(19) United States
(12) Patent Application Publication
(10) Pub. No.: US 2023/0160794 A1
(43) Pub. Date: May 25, 2023

(54) METHODS FOR SAMPLE PREPARATION FOR AUTOMATED IN SITU ANALYSIS

(71) Applicant: 10x Genomics, Inc., Pleasanton, CA (US)

(72) Inventors: Rhyan Blaine DOCKTER, Logan, UT (US); David HOFFMAN, Pleasanton, CA (US)

(21) Appl. No.: 17/993,330

(22) Filed: Nov. 23, 2022

Related U.S. Application Data
(60) Provisional application No. 63/283,148, filed on Nov. 24, 2021.

(51) Int. Cl. G01N 1/31; G02B 21/34; G01N 21/64; G06T 7/00

(52) U.S. Cl. CPC G01N 1/312; G01N 21/6458; G02B 21/34; G06T 7/0012; B01L 2300/021; B01L 2300/0822

(57) ABSTRACT

The present disclosure relates to methods for preparing biological samples for in situ analysis of one or more analytes wherein the biological sample has been previously affixed to a substrate, which in some cases may not be compatible with in situ analysis, for example, due to the absence of positional markers and/or fiducial markers and/or a region suitable for in situ signal detection on the substrate. In some aspects, a hydrophobic adapter having positional markers and/or fiducial markers is applied to the substrate to which a biological sample has been affixed, thus enabling in situ sample processing and analysis of the biological sample. The hydrophobic adhesive label or adapter can be used for automated microscope alignment and sample preparation.

### CROSS-REFERENCE TO RELATED APPLICATION

This application claims priority to U.S. Provisional Pat. Application No. 63/283,148, filed Nov. 24, 2021, entitled “METHODS FOR SAMPLE PREPARATIONS FOR AUTOMATED IN SITU ANALYSIS,” which is herein incorporated by reference in its entirety for all purposes.

### FIELD

The present disclosure relates in some aspects to methods, devices, components, and kits for sample processing and analysis, such as devices, components (e.g., a hydrophobic adhesive adapter), and methods of using the components for preparing a sample for in situ analysis of analytes in the sample.

### BACKGROUND

Transcription profiling of cells is essential for many purposes, such as understanding the molecular basis of cell identity and/or function and developing treatments for diseases. Microscopy imaging, which can resolve multiple mRNAs in single cells, can provide valuable information such as transcript abundance and spatial information in situ. Methods are available for analyzing nucleic acids present in a biological sample, such as a cell or a tissue. For instance, advances in single molecule fluorescence in situ hybridization (smFISH) have enabled nanoscale-resolution imaging of RNA in cells and tissues.

Existing methods of in situ analysis often employ particular substrates to which biological samples are affixed, such as specialized glass slides modified with positioning and/or fiducial markers, in order to serve as part of the in situ analysis and facilitate downstream interpretation. However, many biological samples may be affixed to substrates lacking one or more of these modifications. In other cases, there may be interest in applying in situ analytical techniques to archival biological samples that may have been originally intended for other techniques and immobilized to substrates that in some cases may be incompatible with in situ methods. In such instances, the biological samples are not readily examined with in situ analysis methods. Improved methods for sample processing and in situ analysis are needed. The present disclosure addresses these and other needs.

### SUMMARY

In some aspects, provided herein are methods for preparing biological samples for sample processing and/or in situ analysis of one or more analytes (e.g., nucleic acid and/or protein molecules). In some embodiments, disclosed herein are methods of processing biological samples affixed to substrates that are not compatible with and/or are not specialized for in situ analysis such as in situ transcriptomic profiling. In some embodiments, disclosed herein are methods of adapting a biological sample affixed to an unmarked or partially unmarked substrate, in order to facilitate sample processing and analysis of one or more analytes in situ in the biological sample, by applying an adapter, which may be made of hydrophobic material or may have hydrophobic coatings or functionalization, to the substrate.

In one aspect, provided herein is a method for analyzing a biological sample on a substrate, comprising a) applying an adapter to the substrate, wherein the adapter comprises a top surface and a bottom surface, and a through hole surrounding a region of interest in the biological sample, wherein: the bottom surface forms a substantially impervious seal with the substrate, and an area of the adapter surrounding the region of interest is hydrophobic; b) delivering a hydrophilic composition to cover the region of interest, wherein the hydrophilic composition covering the region of interest is contained in the through hole by the substantially impervious seal and the hydrophobic area surrounding the region of interest, wherein the method does not comprise applying a cover to the adapter to enclose or cover the region of interest. In some embodiments, the cover can be a cover slip such as a glass or plastic cover slip.

In any of the embodiments herein, the adapter can comprise one or more positional markers and/or fiducial markers on the top surface, on the bottom surface, and/or within the adapter. In any of the embodiments herein, the one or more positional markers and/or fiducial markers can be printed, etched, stamped, imprinted, and/or burned on the top surface or the bottom surface or embedded in the adapter. In any of the embodiments herein, the one or more positional markers and/or fiducial markers can comprise a fluorescent material, a metal, or a combination thereof. In any of the embodiments herein, the one or more positional markers and/or fiducial markers can comprise a pre-configured shape and/or pattern.

In any of the embodiments herein, the adapter can be composed of a hydrophobic and chemically inert material. In any of the embodiments herein, the adapter can be compatible with experimental assays. In any of the embodiments herein, the adapter can be resistant to chemical leeching. In any of the embodiments herein, the adapter can be resistant to decomposition in solution. In any of the embodiments herein, the adapter can be composed of a heat stable material. In any of the embodiments herein, the adapter can be composed of polypropylene, polytetrafluoroethylene (PTFE), any silica-based materials, and/or paraffin coated materials. In any of the embodiments herein, the adapter can comprise a hydrophobic coating on an inner surface of the through hole, the top surface of the adaptor or a portion of the top surface surrounding the region of interest, and/or on the bottom surface of the adaptor or a portion of the bottom surface surrounding the region of interest.

In any of the embodiments herein, the thickness of the adapter between the top surface and the bottom surface can be no more than about 0.5 mm, no more than about 0.4 mm, no more than about 0.3 mm, no more than about 0.2 mm, or no more than about 0.1 mm. In any of the embodiments herein, the thickness of the adapter between the top surface and the bottom surface can be no more than about 100 µm, no more than about 90 µm, no more than about 80 µm, no more than about 70 µm, no more than about 60 µm, no more than about 50 µm, no more than about 40 µm, no more than about 30 µm, no more than about 20 µm, or no more than about 10 µm. In any of the embodiments herein, the hydrophilic composition contained in through hole can have a convex surface.

In any of the embodiments herein, the inner surfaces of the through hole can be hydrophobic and/or impervious to the hydrophilic composition. In any of the embodiments herein, the top surface can be hydrophobic and/or impervious to the hydrophilic composition. In any of the embodiments herein, the bottom surface can be hydrophobic and/or impervious to the hydrophilic composition. In any of the embodiments herein, the method can comprise modifying the area surrounding the region of interest to be hydrophobic or more hydrophobic than prior to the modification.

In any of the embodiments herein, the adapter may not comprise a silicone. In any of the embodiments herein, the adapter can be composed of a substantially non-elastic material. In any of the embodiments herein, the adapter can be substantially rigid. In any of the embodiments herein, the adapter can be flexible.

In any of the embodiments herein, the adapter may not need to be secured to the substrate by any physical device and/or structure or sandwiched between the substrate and any physical device and/or structure. In any of the embodiments herein, the adapter may not need to be secured to the substrate by a clip or clamp.

In any of the embodiments herein, the bottom surface and/or its corresponding surface on the substrate can be adhesive. In any of the embodiments herein, the bottom surface and its corresponding surface on the substrate can be bonded by an adhesive material. In any of the embodiments herein, the adapter may contain an adhesive on its top surface and an adhesive on its bottom surface. In any of the embodiments herein, the adapter can be in the form of a double-side tape. In any of the embodiments herein, the bottom surface can be removable from the substrate.

In any of the embodiments herein, the method can comprise selecting the adapter with a pre-configured through hole size and/or shape according to the size and/or shape of the region of interest, such that the selected adapter surrounds the region of interest upon application to the substrate. In any of the embodiments herein, the method can comprise customizing the size and/or shape of the through hole according to the size and/or shape of the region of interest, such that the customized adapter surrounds the region of interest upon application to the substrate.

In any of the embodiments herein, the substrate can be or comprise a pre-prepared or archived substrate comprising the biological sample immobilized thereon. In any of the embodiments herein, the substrate can be or comprise a slide.

In any of the embodiments herein, the adapter can be applied to the substrate according to the location of the biological sample on the substrate and/or according to the location of the region of interest in the biological sample. In any of the embodiments herein, the region of interest can be the entire biological sample. In any of the embodiments herein, the region of interest can be a portion of the biological sample. In any of the embodiments herein, the through hole may surround the entire biological sample and optionally a region of the substrate not covered or occupied by the biological sample. In any of the embodiments herein, the through hole may surround the entire biological sample and a region of the substrate not covered or occupied by the biological sample. In any of the embodiments herein, the through hole may surround a portion of the biological sample and optionally a region of the substrate not covered or occupied by the biological sample. In any of the embodiments herein, the through hole may surround a portion of the biological sample and a region of the substrate not covered or occupied by the biological sample. In any of the embodiments herein, the biological sample can be a tissue section or a sample of adherent cells. In any of the embodiments herein, the biological sample may not be embedded in a matrix. In any of the embodiments herein, the biological sample may not be embedded in a hydrogel matrix.

In any of the embodiments herein, the hydrophilic composition can be or comprise water. In any of the embodiments herein, the hydrophilic composition can be or comprise an aqueous solution. In any of the embodiments herein, the hydrophilic composition can be delivered to the through hole via an opening on the top surface that extends to the bottom surface. In any of the embodiments herein, the through hole opening on the top surface may not be covered when delivering the hydrophilic composition in step (b).

In any of the embodiments herein, the adapter can comprise one or more barcodes, optionally a one-dimensional barcode or a two-dimensional barcode, optionally wherein the two-dimensional barcode is a QR code. In any of the embodiments herein, the adaptor can comprise one and/or more one-dimensional or two-dimensional barcodes. In any of the embodiments herein, the adaptor can comprise one or more two-dimensional barcodes that are QR codes. In any of the embodiments herein, the one or more positional markers and/or fiducial markers and/or the one or more barcodes can be configured to be recognized by a microscope, optionally wherein the microscope is a fluorescence microscope, and/or a computer, optionally wherein the computer is used for sample alignment and image analysis. In any of the embodiments herein, the microscope is a fluorescence microscope. In any of the embodiments herein, the computer is used for sample alignment and image analysis. In any of the embodiments herein, the microscope and/or computer can be automated to recognize the one or more positional markers and/or fiducial markers and/or the one or more barcodes. In any of the embodiments herein, in step (b), the delivery of the hydrophilic composition to cover the region of interest can be automated according to information extracted by the microscope and/or computer from the one or more positional markers and/or fiducial markers and/or the one or more barcodes. In any of the embodiments herein, imaging of the region of interest can be automated according to information extracted by the microscope and/or computer from the one or more positional markers and/or fiducial markers and/or the one or more barcodes.

In any of the embodiments herein, the method can further comprise c) allowing a reaction between a molecule in the region of interest and one or more agents in the hydrophilic composition. In any of the embodiments herein, the method can further comprise d) detecting a signal associated with the reaction or a product thereof, thereby detecting the molecule in situ in the biological sample, optionally wherein the detection is by dipping an objective of a microscope in the hydrophilic composition. In any of the embodiments herein, the detection may be by dipping an objective of a microscope in the hydrophilic composition. In any of the embodiments herein, the method can further comprise e) removing the hydrophilic composition after the reaction from the through hole through its opening on the top surface. In any of the embodiments herein, the method can further comprise f) delivering another hydrophilic composition to cover the region of interest and repeating steps (c)-(e) in one or more sequential cycles. In some aspects, provided herein is a method comprising one or more steps which are automated, and the method can comprise steps (b)-(f) of any of the preceding embodiments which are automated.

In some embodiments, provided herein is a method for analyzing a biological sample, comprising: (a) applying an adapter to a planar substrate having the biological sample immobilized thereon, wherein: the adapter comprises a top surface and a bottom surface, and a through hole surrounding a region of interest in the biological sample, wherein: the bottom surface forms a substantially impervious seal with the planar substrate; and an area of the adapter surrounding the region of interest is hydrophobic; (b) delivering a hydrophilic composition to cover the region of interest, wherein the hydrophilic composition covering the region of interest is contained in the through hole by the substantially impervious seal and the hydrophobic area surrounding the region of interest; (c) allowing a reaction between a molecule in the region of interest and one or more agents in the hydrophilic composition; (d) dipping an objective of a microscope in the hydrophilic composition contained in the through hole; and (e) detecting a signal associated with the reaction or a product thereof through the objective dipped in the hydrophilic composition, thereby detecting the molecule in situ in the biological sample. In some embodiments, the adapter comprises one or more positional markers and/or fiducial markers on the top surface, on the bottom surface, and/or within the adapter. In any of the embodiments herein, the thickness of the adapter between the top surface and the bottom surface can be no more than about 100 µm, no more than about 90 µm, no more than about 80 µm, no more than about 70 µm, no more than about 60 µm, no more than about 50 µm, no more than about 40 µm, no more than about 30 µm, no more than about 20 µm, or no more than about 10 µm. In any of the embodiments herein, the bottom surface and its corresponding surface on the planar substrate can be bonded by an adhesive material.

In yet another aspect, provided herein is an adapter, comprising a top surface and a bottom surface, and a through hole configured to surround a region of interest in a biological sample, wherein: the adapter contains an adhesive on its bottom surface and/or an adhesive on its top surface, optionally in the form of a double-side tape; the adapter comprises one or more positional markers and/or fiducial markers on the top surface, on the bottom surface, and/or within the adapter; an area of the adapter configured to surround the region of interest is hydrophobic; and optionally the thickness of the adapter between the top surface and the bottom surface is no more than about 200 µm. In any embodiments herein, the adaptor may be in the form of a double-sided tape. In any embodiments herein, the thickness of the adaptor is no more than about 200 µm. In any embodiments of the present aspect, the one or more positional markers and/or fiducial markers are printed, etched, stamped, imprinted, and/or burned on the top surface or the bottom surface or embedded in the adapter. In any of the embodiments herein, the one or more positional markers and/or fiducial markers comprise a fluorescent material, a metal, or a combination thereof. In any of the embodiments herein, the one or more positional markers and/or fiducial markers comprise a pre-configured shape and/or pattern. In any of the embodiments herein, the thickness of the adapter between the top surface and the bottom surface is no more than about 100 µm, no more than about 90 µm, no more than about 80 µm, no more than about 70 µm, no more than about 60 µm, no more than about 50 µm, no more than about 40 µm, no more than about 30 µm, no more than about 20 µm, or no more than about 10 µm. In any of the embodiments herein, the hydrophilic composition contained in through hole can have a convex surface. In any of the embodiments herein, the adapter is composed of a hydrophobic and chemically inert material, is compatible with experimental assays, is resistant to chemical leeching, is resistant to decomposition in solution, and/or is a heat stable material. In any of the embodiments herein, the adapter is composed of polypropylene, polytetrafluoroethylene (PTFE), any silica-based materials, and/or paraffin coated materials. In any of the embodiments herein, the adapter comprises a hydrophobic coating on an inner surface of the through hole, the top surface of the adaptor or a portion of the top surface surrounding the region of interest, and/or on the bottom surface of the adaptor or a portion of the bottom surface surrounding the region of interest. In any of the embodiments herein, the through hole runs from the top surface to the bottom surface of the adapter, the top surface is hydrophobic, and the bottom surface is configured to form a substantially impervious seal with a substrate. In any of the embodiments herein, the adapter does not comprise a silicone; wherein the adapter is composed of a substantially non-elastic material; wherein the adapter is substantially rigid; wherein the adapter is flexible; wherein the adapter is not secured to a substrate by any physical device and/or structure or sandwiched between the substrate and any physical device and/or structure; wherein the adapter is not secured to a substrate by a clip or clamp; and/or wherein the adapter does not comprise a clip or clamp.

In yet another aspect, provided herein is a kit comprising any adapter disclosed herein and a planar substrate, wherein the bottom surface of the adaptor is configured to form a substantially impervious seal with the planar substrate.

### DESCRIPTION OF THE FIGURES

The present application can be understood by reference to the following description taken in conjunction with the accompanying figures that illustrate certain embodiments of the features and advantages of this disclosure. These embodiments are not intended to limit the scope of the appended claims in any manner.

FIG. 1 depicts different views of an exemplary adapter according to the present disclosure. FIG. 1 shows a top view of an exemplary adapter 100 having a through hole of some shape and size 102 (as illustrated by the dotted line) and positional markers and/or fiducial markers 104 for use in biological sample preparation and in situ analysis. In some embodiments, the shape of the through hole is rectangular or circular. The adapter 100 comprises a top surface and a bottom surface, and a through hole 102 surrounding and defining a space 106. The adapter 100 may optionally also include a unique identification marker 108, such as a bar code or QR code, individualized to a specific biological sample and/or processing conditions. The inclusion of the unique identification marker 108 may facilitate automation of any downstream sample processing and/or analysis. The adapter 100 may itself be made of a hydrophobic material and/or may further comprise a hydrophobic coating or surface functionalization, not shown, on an inner surface of the through hole, the top surface of the adaptor or a portion of the bottom surface surrounding the region of interest, and/or on the bottom surface of the adaptor or a portion of the bottom surface surrounding the region of interest, to deter attachment of a biological sample, a hydrophilic composition, and/or any other analytes. In some embodiments, the through hole of the adapter can be configured such that the space is created. In some embodiments, the adapter is configured to surround an exemplary biological sample (e.g., tissue sample) comprising a region of interest, contained within the space.

FIG. 2 depicts an exemplary substrate 200 and an exemplary biological sample (e.g., tissue sample) 202 surrounded by an exemplary adapter 204 having positional markers and/or fiducial markers 206 and, optionally, a unique identification marker 212. FIG. 2 shows a top view. In FIG. 2, one embodiment of the exemplary adapter 204 comprises positional markers and/or fiducial markers 206 and a through hole 208 which surrounds a space 210 containing the biological sample affixed to the substrate for in situ analysis. The exemplary region may comprise modifications such as surface functionalization (e.g., to facilitate sample attachment) and/or have specifications (e.g., thickness or other physical, optical or chemical properties) that would facilitate in situ signal detection and/or analysis. The bottom surface of the adapter forms a substantially impervious seal with the surface of the substrate 200 with which it is in contact. The adapter 204 is made of hydrophobic material and/or comprises a hydrophobic coating or surface functionalization, not shown, on an inner surface of the through hole, the top surface of the adaptor or a portion of the top surface surrounding the region of interest, and/or on the bottom surface of the adaptor or a portion of the bottom surface surrounding the region of interest, to deter attachment of a biological sample, a hydrophilic composition, and/or any other analytes. In some embodiments, the through hole of the adapter can be configured such that the biological sample and any region of interest therein is fully contained within the space. In some embodiments, one or more hydrophilic compositions can be added to, maintained in and/or removed from the space 210 to enable and/or enhance sample processing and/or analysis, including but not limited to in situ analysis and imaging.

FIGS. 3A-3D depict an exemplary process 301 according to the present disclosure for preparing and analyzing an exemplary biological sample affixed to an exemplary substrate for in situ analysis, as shown from a cut-out side view for each step. In step 303, a biological sample 302 immobilized to a substrate 300 is fitted with an adapter 304 wherein the adapter has positional markers and/or fiducial markers 306 and a substantially impervious seal 318 between the bottom surface of the adapter and the substrate is established. The adapter, having a through hole 308, is configured to the substrate to form a space 310 surrounding and/or containing the biological sample having a region of interest. In step 305, a hydrophilic composition 312 is added to the space 310 containing the biological sample or a region of interest thereof, wherein the substantially impervious seal 318 facilitates the containment of the hydrophilic compositions. The hydrophilic composition 312, which comprises one or more reagents for sample processing or analysis, is delivered to the space and the biological sample or region of interest contained therein. Multiple hydrophilic compositions may be added in combination or serially to the biological sample as suitable for the particular processing and/or analytic technique being applied. As shown in FIG. 3C, the biological sample 302 is submerged in the hydrophilic composition 312 and is positioned on the substrate 300, such that the biological sample and positional markers and/or fiducial markers of the adapter are visible and the biological sample is accessible via the through hole of the adapter for processing and in situ analysis. Once a hydrophobic adapter has been applied to a substrate with a biological sample immobilized to the surface of the substrate, a hydrophilic composition can be added to the sample well formed by the substrate and the through hole of the adapter. The hydrophilic composition is contained within the sample well due to repulsion by the hydrophobic surfaces of the adapter and/or surface tension of the liquid and forms a controlled liquid volume, the surface of which as an interface with a dipping objective for downstream microscopy. In FIG. 3D, after step 307, a dipping objective 314 is lowered directly onto the surface 316 of the hydrophilic composition 312 to visualize and/or capture in situ analysis data.

### DETAILED DESCRIPTION

All publications, comprising patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

The section headings used herein are for organizational purposes only and are not to be construed as limiting the subject matter described.

Provided herein, in some aspects, are methods for preparing biological samples for processing and in situ analysis. In some embodiments, the methods provided herein are methods for applying a hydrophobic adhesive adapter to sample substrates to enable open-well sample preparation and automated sample analysis.

In certain embodiments, the sample substrates prepared and obtained according to the methods provided herein may further be used in or for methods for detecting the presence of and/or quantifying analytes, such as nucleic acids, in cells, tissues, organs or organisms. In some embodiments, the present disclosure provides methods for high-throughput profiling of a large number of targets in situ, including spatial information of such targets, such as RNA transcripts and/or DNA loci in a tissue sample.

### I. Overview

Prior to the imaging of such biological samples, the biological samples are typically processed and affixed to substrates (e.g., slides), and embedded in three-dimensional polymerized matrices, such as hydrogel matrices, to prevent detachment from microscopy slides, to preserve relative spatial information of the tissue (e.g., link any molecule of interest to its original location for colocalization with other molecules of interest), and to mitigate sample degradation. The fixation of biological samples, such as tissue sections, to substrates, such as microscopy slides, and subsequent embedding of the biological samples in three-dimensional polymerized matrices, e.g., hydrogel matrices, is useful in sample preparation for stabilizing the integrity of biological samples for handling and allowing for further downstream treatment of the biological sample to facilitate analysis, such as in situ analysis. For example, after being affixed to a suitable substrate, such as a glass slide, and being embedding into a hydrogel matrix, a biological sample may be subjected to any number of post-processing steps including but not limited to clearing, cross-linking, expansion, etc., with reduced risk of damage to and decreased structural instability of the biological sample.

In some circumstances, specialized substrates suited for a specific analytical technique to be performed may be used. For example, in situ analysis such as transcriptional profiling may involve analytes present at low concentrations, such as nucleic acids, and may rely upon highly sensitive measurements, for example, single molecule fluorescence signals. As such, in situ analysis may use specialized substrates for downstream analyses. For example, specialized substrates may be modified with positional markers and/or fiducial markers in order to allow for identification or alignment. These modifications of the substrate function not only as part of the in situ analysis but may also facilitate subsequent interpretation. Specialized substrates having these modifications or attributes may be referred to interchangeably as “modified”, “marked” or “in situ” substrates in the present disclosure.

However, many biological samples may not be affixed to specialized substrates but instead to substrates that are not specialized (e.g., for in situ analysis) such as unmodified substrates, which includes substrates that are partially modified but missing one or more elements required to support in situ analysis). Whether out of convenience or due to intended use with other analytical techniques that do not require specifications and/or modifications for in situ analysis, non-specialized substrates (e.g., unmodified plastic or glass slides) may not be compatible with the in situ assay and, thus, any biological samples affixed to these non-specialized substrates may not be readily examined by existing in situ analysis methods. As provided herein, such substrates without modifications for in situ analysis may be referred to interchangeably as “unmarked”, “partially marked,” “non-specialized”, “partially specialized,” “unmodified,” and/or “partially modified” substrates. Improved methods for sample processing and in situ analysis are needed, particularly for allowing measurement of biological samples affixed to substrates that are not compatible with or not designed for in situ analysis, such as in situ sequencing or in situ hybridization. In some cases, specialized substrates with positional markers and/or fiducial markers may be more costly than non-specialized substrates and such specialized substrates may require special manufacturing steps.

Furthermore, in many instances, multiple rounds of in situ analysis on the same biological sample are highly desired. However, the process of embedding biological samples in three-dimensional polymerized matrices, such as hydrogels, and working with the embedded samples themselves requires additional steps and chemical compatibility considerations for initial sample preparation as well as subsequent treatments of stripping, washing, and hybridization for multiple rounds of in situ analysis. Thus, improved methods for sample processing and in situ analysis are needed, particularly for allowing measurement of biological samples that allow for rapid, multiplexed in situ analysis.

The present disclosure addresses these needs by providing methods for preparing and processing biological samples for in situ analysis by applying a hydrophobic adapter component to the biological sample and unmodified or partially modified substrate, such that the unmodified or partially modified substrate affixed with the adapter described herein is compatible with the steps of sample processing and subsequent in situ analysis to be carried out on the biological sample. In some embodiments, application of the adapters provided herein may modify a non-specialized substrate with an existing biological sample in a cost effective manner to be compatible with the steps for in situ analysis. The hydrophobic adapters of the present disclosure may further obviate the need for embedding biological samples in hydrogel matrices, by providing a sample well, formed by the adapter and the substrate, which contains the biological sample and hydrophilic liquid compositions that can be delivered to the biological sample for pre-analysis sample processing and for in situ analysis, particularly multiplexed in situ analysis. The hydrophobic nature of the adapters contains hydrophilic liquid compositions in a controlled volume, and thus provides a liquid interface for microscopy on the sample, for example, by way of a dipping objective.

### II. Sample Adapter Methods

The present disclosure provides methods for processing a biological sample affixed or immobilized to an unmodified or partially modified substrate, comprising applying an adapter to the substrate, wherein the adapter comprises one or more elements, such as hydrophobic materials or hydrophobic surface functionalization, one or more positioning markers and/or fiducial markers, or unique identification markers, to make the sample compatible with in situ analysis and/or to facilitate in situ analysis, as well as the adapters used therefor. The methods provided herein also comprise the delivery of one or more hydrophilic compositions to the biological samples as part of sample preparation and/or the in situ analysis. In some embodiments, the methods provided herein further comprise use of a dipping objective to perform the in situ analysis. In some embodiments, application of the adapter to the substrate to which the biological sample is affixed enables automation of sample processing and analysis.

In one aspect of the present disclosure, provided herein is a method for analyzing a biological sample on a substrate, comprising a) applying an adapter to the substrate, wherein the adapter comprises a top surface and a bottom surface, and a through hole surrounding a region of interest in the biological sample, wherein: the bottom surface forms a substantially impervious seal with the substrate, and an area of the adapter surrounding the region of interest is hydrophobic; b) delivering a hydrophilic composition to cover the region of interest, wherein the hydrophilic composition covering the region of interest is contained in the through hole by the substantially impervious seal and the hydrophobic area surrounding the region of interest, wherein the method does not comprise applying a cover to the adapter to enclose the region of interest, optionally wherein the cover is a cover slip.

In some embodiments, provided herein is a method further comprising c) allowing a reaction between a molecule in the region of interest and one or more agents in the hydrophilic composition. In some embodiments, the method further comprises d) detecting a signal associated with the reaction or a product thereof, thereby detecting the molecule in situ in the biological sample, optionally wherein the detection is by dipping an objective of a microscope in the hydrophilic composition. In some embodiment, the detection is by dipping an objective of a microscope in the hydrophilic composition. In some embodiments, the method further comprises e) removing the hydrophilic composition after the reaction from the through hole through its opening on the top surface. In some embodiments, the method further comprises f) delivering another hydrophilic composition to cover the region of interest and repeating steps (c)-(e) in one or more sequential cycles. In some embodiments, provided herein is a method comprising one or more steps are automated, optionally wherein steps (b)-(f) are automated. In some embodiments, steps (b)-(f) are automated.

In other aspects of the present disclosure, provided herein are methods that involve the application of an adapter to the biological sample affixed to an unmodified or partially modified substrate, which makes the biological sample and the unmodified or partially modified substrate to which the sample is affixed compatible with in situ analytical methods (or which facilitates in situ analytical methods), and adapters therefor. In one aspect, provided herein are methods that wherein the adapter comprises one or more modifications that are compatible with and/or facilitate in situ analytical methods, such as positional markers and/or fiducial markers. In another aspect, the adapter comprises one or more modifications that are compatible with and/or facilitate in situ analytical methods, such as a through hole which, together with the substrate to which the biological sample it is affixed, may form a space to which a hydrophilic composition can be delivered such that the hydrophilic composition may contact a region of interest in the biological sample.

### A. Adapter

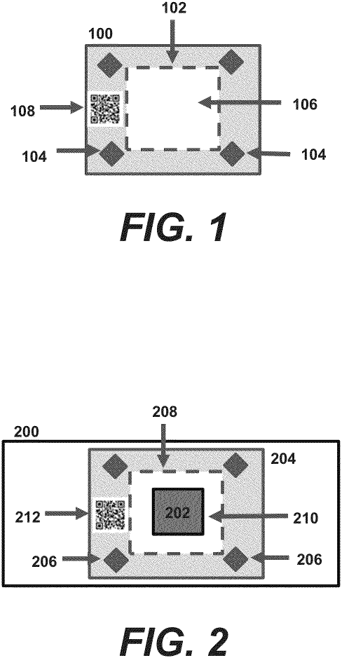

In one aspect, provided herein is an adapter for in situ analysis, or more specifically, an adapter for adapting a biological sample affixed to a substrate that in some cases may be incompatible with in situ analysis. In some embodiments, the adapter comprises a top surface and a bottom surface, and a through hole that extends from the top surface to the bottom surface. An exemplary adapter 100 for in situ analysis is shown in FIG. 1. In some embodiments, the through hole 102 defines a space 106 that can surround and/or contain a biological sample (e.g., tissue sample) affixed to a substrate. In some embodiments, the adapter comprises an inner surface created by the through hole. In some embodiments, the adapter inner surface, the top surface, and/or the bottom surface is hydrophobic and/or impervious to the hydrophilic composition.

As described herein, the adapters of the present disclosure may facilitate in situ analysis allowing for a biological sample affixed to a substrate to be oriented and aligned for in situ measurements, during data collection and/or for subsequent data analysis. A suitable positioning marker or fiducial marker may indicate the relative spatial orientation of the biological sample to be evaluated. Again, in reference to FIG. 1, exemplary positioning markers and/or fiducial markers are shown at 104. In some embodiments, the adapter comprises one or more positional markers and/or fiducial markers. In some embodiments, the positional markers and/or fiducial markers are printed, etched, stamped, imprinted, and/or burned on the top surface or the bottom surface or embedded in the adapter. In some embodiments, the positional markers and/or fiducial markers comprise a fluorescent material, a metal, or a combination thereof. In some embodiments, the positional markers and/or fiducial markers comprise a pre-configured shape and/or pattern. In some embodiments, the adapter comprise one or more positional markers and/or fiducial markers, such as a laser fiducial marker, to facilitate positioning and location of the adapter and/or any biological sample in any subsequent measurement and analysis, for example, in microscope imaging.

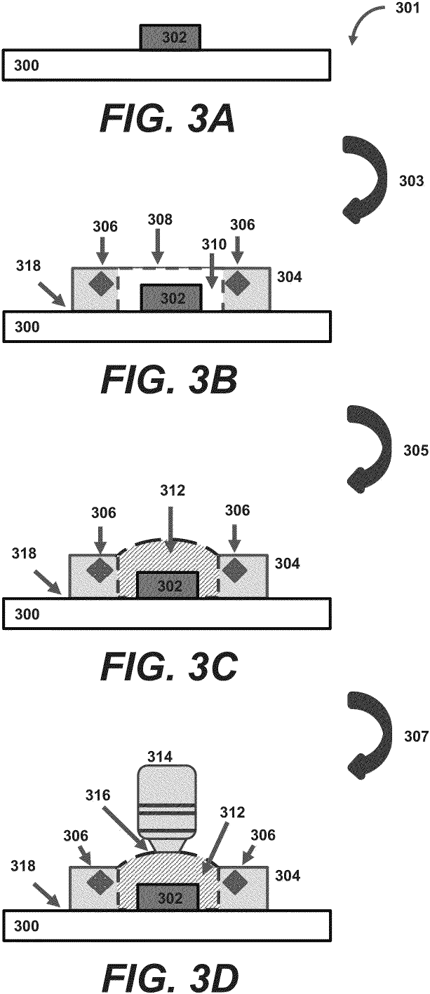

As described herein, the adapters of the present disclosure may also facilitate in situ analysis of samples without the need to embed biological samples in polymerized matrices, such as hydrogel matrices. The adapters of the present disclosure achieve this end by enabling the formation of long-lasting, controlled volumes of hydrophilic compositions that cover the biological sample and can serve as a liquid interface for microscopy measurements, such as shown at 316 in FIG. 3D. The formation of these controlled volumes of hydrophilic compositions is achieved by employing hydrophobic materials in or on one or more surfaces of the adapter to repel and contain the spread of the hydrophilic compositions.

In some embodiments, the adapter is composed of a hydrophobic and chemically inert material, is compatible with experimental assays, is resistant to chemical leeching, and/or is resistant to decomposition in solution. Suitable hydrophobic and chemically inert material may include but are not limited to Polypropylene, Polytetrafluoroethylene (PTFE), and other silica-based materials, paraffin coated materials. In some embodiments, the adapter is composed of polypropylene, polytetrafluoroethylene (PTFE), any silica-based materials, and/or paraffin coated materials. In some embodiments, the adapter comprises a hydrophobic coating on an inner surface of the through hole, the top surface of the adaptor or a portion of the top surface surrounding the region of interest, and/or on the bottom surface of the adaptor or a portion of the bottom surface surrounding the region of interest. In some embodiments, the adapter comprises an inner surface created by the through hole, wherein the inner surface is hydrophobic and/or impervious to the hydrophilic composition. In some embodiments, the top surface is hydrophobic and/or impervious to the hydrophilic composition. In some embodiments, the bottom surface is hydrophobic and/or impervious to the hydrophilic composition. In some embodiments, the adapter is composed of a heat stable material.

In some embodiments, the adapter does not comprise a silicone. In some embodiments, the adapter is composed of a substantially non-elastic material. In some embodiments, the adapter is substantially rigid. In some embodiments, the adapter is flexible.

In some embodiments, the adapter has a thickness between the top surface and the bottom surface, wherein the thickness of the adapter is no more than about 0.5 mm, no more than about 0.4 mm, no more than about 0.3 mm, no more than about 0.2 mm, or no more than about 0.1 mm. In some embodiments, the thickness of the adapter is no more than about 100 µm, no more than about 90 µm, no more than about 80 µm, no more than about 70 µm, no more than about 60 µm, no more than about 50 µm, no more than about 40 µm, no more than about 30 µm, no more than about 20 µm, or no more than about 10 µm.

With reference to FIG. 3, the formation of the controlled volumes of hydrophilic compositions as provided in the methods herein is further achieved by the formation of a substantially impervious seal 318 between the bottom surface of the adapter and the substrate, which also facilitates the containment of the hydrophilic compositions. In some embodiments, the adapter comprises an adhesive on its bottom surface. In some embodiments, the adapter is attached to the substrate via an adhesive, optionally in the form of a double-side tape. In some embodiments, the adhesive is in the form of a double-sided tape.

In some embodiments, the adapter has a bottom surface comprising an adhesive material. The adhesive material may be characterized by its chemical composition, wherein the adhesive material is preferably non-reactive and/or inert to any biological samples or associated reagents for sample processing or analysis.

In some embodiments, the adapter is attached to the substrate via an adhesive material, optionally in the form of a double-side tape. In some embodiments, the adapter is attached to the substrate via adhesive material, in the form of a double-sided tape. The adhesive material may be characterized by its chemical composition and dimensions, such as thickness, wherein the adhesive material is preferably non-reactive and/or inert to any biological samples or associated reagents for sample processing or analysis.

FIG. 2 illustrates an exemplary adapter 204 having a through hole 208, which forms a space 210 surrounding and encompassing a biological sample 202 on a substrate 200. The shape and size of the through hole of the adapter, which forms the boundary of the space along with the substrate, may be configured to accommodate the shape and size of the biological sample (or a region of interest of the sample) contained as well as provide a certain desired volume of void space for the hydrophilic compositions to be delivered to. In some embodiments, the adapter comprises a pre-configured through hole size and/or shape according to the size and/or shape of the region of interest. In some embodiments, the adapter is configured to be customized, prior to application, in size and/or shape of the through hole according to the size and/or shape of the region of interest. In some embodiments, the space formed in the through hole by the adapter and the substrate has a void volume of at least about 10 µL, of at least about 20 µL, of at least about 30 µL, of at least about 40 µL, of at least about 50 µL, of at least about 100 µL, of at least about 200 µL, of at least about 300 µL, of at least about 400 µL, of at least about 500 µL, of at least about 600 µL, of at least about 700 µL, of at least about 800 µL, or of at least about 900 µL. In other embodiments, the space has a void volume of less than or equal to about 20 µL, of less than or equal to about 30 µL, of less than or equal to about 40 µL, of less than or equal to about 50 µL, of less than or equal to about 100 µL, of less than or equal to about 200 µL, of less than or equal to about 300 µL, of less than or equal to about 400 µL, of less than or equal to about 500 µL, of less than or equal to about 600 µL, of less than or equal to about 700 µL, of less than or equal to about 800 µL, of less than or equal to about 900 µL, or less than or equal to about 1000 µL.

Further, the hydrophilic composition may extend beyond the volume of void space, such as shown at 316 in FIG. 3D, wherein more hydrophilic composition is required for biological sample processing and/or analysis. In some embodiments, the hydrophilic composition comprises one or more reagents, and a volume of the hydrophilic composition applied to the biological sample is contained by the adapter. In some embodiments, the adapter comprises a pre-configured through hole size and/or shape according to the size and/or shape of the region of interest. In some embodiments, the adapter is configured to be customized, prior to application, in size and/or shape of the through hole according to the size and/or shape of the region of interest. In some embodiments, the space formed in the through hole by the adapter and the substrate has a void that is substantially two-dimensional, whereas the volume of the hydrophilic composition contained by the adapter is three-dimensional and extends beyond the substantially two-dimensional void (e.g., due to repulsion by the hydrophobic surfaces of the adapter and/or surface tension of the hydrophilic composition). In some embodiments, a hydrophilic composition is applied to the biological sample, e.g., through the through hole of the adapter, and all or a portion of the applied volume is contained/retained by the adapter. The contained/retained volume of the hydrophilic composition can be substantially two-dimensional or can be three-dimensional. In further embodiments, the volume of the hydrophilic composition contained/retained by the adapter has a volume of at least about 10 µL, of at least about 20 µL, of at least about 30 µL, of at least about 40 µL, of at least about 50 µL, of at least about 100 µL, of at least about 200 µL, of at least about 300 µL, of at least about 400 µL, of at least about 500 µL, of at least about 600 µL, of at least about 700 µL, of at least about 800 µL, or of at least about 900 µL. In further embodiments yet, the volume of hydrophilic composition contained/retained by the adapter has a volume of less than or equal to about 20 µL, of less than or equal to about 30 µL, of less than or equal to about 40 µL, of less than or equal to about 50 µL, of less than or equal to about 100 µL, of less than or equal to about 200 µL, of less than or equal to about 300 µL, of less than or equal to about 400 µL, of less than or equal to about 500 µL, of less than or equal to about 600 µL, of less than or equal to about 700 µL, of less than or equal to about 800 µL, of less than or equal to about 900 µL, or less than or equal to about 1000 µL.

In some embodiments, the adapter is applied to the substrate according to the location of the biological sample on the substrate and/or according to the location of the region of interest in the biological sample. In some embodiments, the region of interest is the entire biological sample. In some embodiments, the region of interest is a portion of the biological sample. In some embodiments, the biological sample is a tissue section or a sample of adherent cells. In contrast to existing methods for in situ analysis, the methods of the present disclosure may be applied to samples without the need for immobilizing biological samples in hydrogel or other polymerized matrices prior to analysis. In some embodiments, the biological sample is not embedded in a matrix. In certain embodiments, the biological sample is not embedded in a three-dimensional polymerized matrix, such as a hydrogel matrix.

In some embodiments, the adapter comprises one or more unique identification markers, including but not limited to one or more barcodes. Barcodes may facilitate the automated execution of sample processing and in situ analysis of a biological sample and substrate fitted with the adapter having such barcodes in addition to allowing later identification of sample processing and analysis history associated with the same biological sample. With reference to FIG. 1, a QR code 108 is employed as an exemplary barcode. In some embodiments, the one or more barcode is a one-dimensional barcode and/or a two-dimensional barcode. In some embodiments, the two-dimensional barcode is a QR code. In some embodiments, the barcode is a high capacity colored two-dimensional (HCC2D) code, a just another barcode (JAB), an aztec code, a data matrix, a near field communication (NFC) tag, and/or a SnapTag. In some embodiments, the adapter comprises one or more positional markers and/or fiducials markers, and/or the one or more barcodes are configured to be recognized by a microscope. In some embodiments, the adapter comprises one or more positional markers and/or fiducials markers, and/or the one or more barcodes are configured to be recognized by a fluorescent microscope. In some embodiments, the adapter comprises one or more positional markers and/or fiducials markers, and/or the one or more barcodes are configured to be recognized by a computer, wherein the computer is used for sample alignment and image analysis. In some embodiments, the microscope and/or computer is automated to recognize the one or more positional markers and/or fiducials markers and/or the one or more barcodes.

In another aspect, provided herein is an adapter for in situ analysis comprising one or more of the features described above. In some embodiments, provided herein is an adapter for adapting a biological sample affixed to a substrate that in some cases may be incompatible with in situ analysis comprising one or more of the features described above.

In one aspect, provided herein is an adapter for a biological sample affixed to substrate for in situ analysis, comprising a top surface and a bottom surface, and a through hole, wherein the through hole surrounds a space which may include or encompass the biological sample; wherein the bottom surface may form a substantially impervious seal with the substrate; and wherein an area of the adapter surrounding the space and/or the biological sample or region thereof is hydrophobic.

### B. Substrates

For analytical techniques, such as microscopy, planar tissue sections or slices are typically affixed to rigid substrates, such as a glass microscopy slides. The properties and characteristics of the substrates may depend on the desired analytical technique to be performed and/or the biological sample being analyzed. For example, in situ analytical techniques may be carried out on biological samples affixed to specialized substrates having surface functionalization to aid adhesion of the sample and/or having positional markers and/or fiducial markers for imaging. In some circumstances, biological samples may be placed on any substrate available at the time or may be archival samples immobilized to substrates incompatible with newer analytical methods. However, options for fixing this incompatibility (e.g., transferring biological samples) are limited and remain challenging. The methods provided herein allow for substrate enhancement, wherein any unmodified or partially modified substrate can be fully enabled for complex biological and methodological analysis, such as in situ analysis.

In some embodiments of the present disclosure, the substrate is an unmodified substrate, which does not have any positional markers and/or fiducial markers for imaging, unique identification marker(s) (e.g., barcode, QR code), and/or a suitable space or sample well for containing hydrophilic compositions for sample processing and/or analysis. In some embodiments, the substrate to which the biological sample is affixed does not have any of the features described herein and is therefore, an unmodified substrate. In other embodiments, the substrate is a partially modified substrate, which is missing at least one of positional markers and/or fiducial markers for imaging, unique identification marker(s) (e.g., barcode, QR code), and/or a suitable space or sample well for containing hydrophilic compositions for sample processing and/or analysis. In some embodiments, the substrate to which the biological sample is affixed does not have positioning markers and/or fiducial markers. In some embodiments, the substrate to which the biological sample is affixed does not have one or more barcodes. In some embodiments, the substrate to which the biological sample is affixed does not have a sample well of sufficient capacity and/or hydrophobicity to accommodate any additional and/or required sample processing and analysis reagents to be added, particularly sample processing and analysis reagents delivered in the form of a hydrophilic composition.

In some embodiments of the present disclosure, the substrate is a glass slide. In some embodiments, a biological sample is affixed to or immobilized on the substrate. In further embodiments, the substrate may comprise one or more chemical or physical modifications to facilitate the placement of any biological sample to the surface of the substrate. Suitable chemical or physical modifications may include but are not limited to coatings or functionalization with one or more substances, which may be adhesive or non-adhesive, and/or recessed cavities.

In some embodiments, the surface of the substrate comprises a coating with or is functionalized with one or more substances to facilitate attachment of a biological tissue. In some embodiments, the one or more substances to facilitate attachment to the surface of the substrate comprise lectins, poly-lysine, antibodies, polysaccharides, or covalently binding moieties, optionally wherein the one or more substances comprises acryloyls. In some embodiments, the one or more substances comprises acryloyls. In other embodiments, the surface of the substrate further comprises a coating with or is functionalized with one or more substances to deter attachment, wherein the one or more substances to facilitate attachment and the one or more substances to deter attachment are patterned to provide an adhesive region and/or a non-adhesive region.

In some embodiments, the substrate is planar. In other embodiments, the surface of the substrate comprises a recessed cavity. Recessed cavities on the substrate may be useful on a substrate for positioning and/or centering any biological sample intended to be fixed or immobilized therein. In some embodiments, the surface of the substrate has a recessed cavity. In some embodiments, the biological sample may be fixed or immobilized to the recessed cavity of the substrate. In some embodiments, the recessed cavity comprises the coating with or is functionalized with the one or more substances to facilitate attachment of a biological sample. In addition, such recessed cavities, together with the space formed by the through hole of the adapter can provide a containing space to serve as an effective sample well for hydrophilic compositions to be added to the biological sample affixed to the recessed cavity. It should be recognized, however, the recessed cavities of the substrate alone may be insufficient to contain the hydrophilic compositions of the present disclosure for various reasons, including but not limited to insufficient volumetric capacity and/or hydrophobicity to provide a controlled volume of hydrophilic composition(s) covering the biological sample affixed to the substrate. As such, the recessed cavities may not provide the long-lasting controlled volume of hydrophilic composition(s) suitable for enabling sample processing and in situ analysis as provided herein in the absence of the adapters described herein.

In some embodiments, the surface of the substrate is flat and does not comprise a recessed cavity or a protrusion. In some embodiments, application of an adaptor disclosed herein to the surface of the substrate creates a hydrophobic area surrounding a region of interest in a biological sample on the surface of the substrate, such that a hydrophilic composition covering the region of interest can be contained by an enclosure formed by the hydrophobic area in the adaptor and the substrate. In some embodiments, the adaptor is thin and has a thickness between its top surface and bottom surface that is no more than about 200 µm, no more than about 150 µm, no more than about 100 µm, no more than about 90 µm, no more than about 80 µm, no more than about 70 µm, no more than about 60 µm, no more than about 50 µm, no more than about 40 µm, no more than about 30 µm, no more than about 20 µm, or no more than about 10 µm. In some embodiments, the hydrophilic composition contained by the thin adaptor and the substrate has a convex surface. In some embodiments, an objective of a microscope is contacted with (e.g., dipped into) the hydrophilic composition contained by the thin adaptor and the substrate, and through the objective dipped in the hydrophilic composition, one or more signals are detected using the microscope, thereby analyzing molecules in the region of interest in the biological sample. In some embodiments, during the signal detection, there is no cover (e.g., a cover slip or the substrate having the biological sample thereon) between the hydrophilic composition and the objective of the microscope. In some embodiments, during the signal detection, there is no other composition or structure besides the hydrophilic composition between the biological sample and the objective of the microscope.

In some embodiments, the substrate lacks any surface functionalization or positioning markers or fiducial markers. In some embodiments, the surface of the substrate does not comprise any coating or is not functionalized with one or more substances to facilitate or deter attachment of a biological tissue. In other embodiments, the substrate does not comprise any positioning markers or fiducial markers. In some embodiments, the substrate does not comprise any positioning markers or fiducial markers on the surface on which the biological sample is fixed or immobilized.

### C. Methods

In one aspect, provided herein is a method for processing and/or analyzing a biological sample, comprising adapting a biological sample affixed to or immobilized on an unmodified or partially modified substrate for in situ analysis, wherein the adapting step comprises applying an adapter to the substrate, the adapter comprises a top surface and a bottom surface, and a through hole surrounding a region of interest in the biological sample, wherein the bottom surface forms a substantially impervious seal with the substrate; and an area of the adapter surrounding the region of interest is hydrophobic; and delivering one or more hydrophilic compositions, in combination or sequentially, to the region of interest, and analyzing the biological sample. In some embodiments, the method does not comprise applying a cover to the adapter to enclose the region of interest, optionally wherein the cover is a cover slip. FIGS. 3A-3D depict an exemplary method 301 for processing and analyzing a biological sample on a substrate.

For the methods of the present disclosure, the adapter can be easily applied to a substrate, and optionally, can also be easily removed from the substrate, which obviates the need for expensive engineering controls to pre-fabricate sample cassettes or adapters having precise dimensions to accommodate the shape and/or size of unique biological samples. In some embodiments, the adaptor can be easily removed from the substrate. As detailed above, the adapters of the present disclosure may be configured to create a customizable space surrounding and/or containing the biological sample or a region of interest thereof, which in turn sets the maximum volume and space that can be used for delivering one or more hydrophilic compositions, as well as physical sample manipulation resulting in a fully enabled substrate and biological sample for in situ analysis. In some embodiments, the adapter can be removed from the substrate after in situ analysis and reapplied for subsequent sample processing and analysis. In some embodiments, the adapter can be removed from the substrate after in situ analysis and reapplied one or more times for subsequent sample processing and analysis.

In another aspect, provided herein is a method for analyzing a biological sample on a substrate, comprising applying an adapter to the substrate, wherein the adapter comprises a top surface and a bottom surface, and a through hole surrounding a region of interest in the biological sample, wherein: the bottom surface forms a substantially impervious seal with the substrate, and an area of the adapter surrounding the region of interest is hydrophobic wherein the biological sample is surrounded and/or contained within a space formed by the through hole; wherein the adapter comprises one or more positional markers and/or fiducial markers on the top surface, on the bottom surface, and/or within the adapter. With reference to FIGS. 3A-3B, in step 303, an adapter 304 is applied to a biological sample 302 affixed to a substrate 300. As further shown in FIG. 3C, the substantially impervious seal 318 between the bottom surface and corresponding surface on the substrate along with the space in the through hole forms an effective sample well to contain a hydrophilic composition 312.

In some embodiments, the adapter is applied to the substrate according to the location of the biological sample on the substrate and/or according to the location of the region of interest in the biological sample. In some embodiments, the region of interest is the entire biological sample. In some embodiments, the region of interest is a portion of the biological sample. In some embodiments, the biological sample is a tissue section or a sample of adherent cells. In some embodiments, the biological sample is not embedded in a matrix. In certain embodiments, the biological sample is not embedded in a hydrogel matrix.

In some embodiments, the method comprises selecting the adapter with a pre-configured through hole size and/or shape according to the size and/or shape of the region of interest, such that the selected adapter surrounds the region of interest upon application to the substrate. In some embodiments, the method comprises customizing the size and/or shape of the through hole according to the size and/or shape of the region of interest, such that the customized adapter surrounds the region of interest upon application to the substrate.

In some embodiments, the method further comprises delivering a hydrophilic composition to cover the region of interest, wherein the hydrophilic composition covering the region of interest is contained in the through hole by the substantially impervious seal and the hydrophobic area surrounding the region of interest, wherein the method does not comprise applying a cover to the adapter to enclose the region of interest, optionally wherein the cover is a cover slip. With further reference to FIGS. 3B-3C, in step 305, a hydrophilic composition 312 is delivered to the space 310 formed by the through hole of the adapter 308 and the substrate 300.

In some embodiments, the hydrophilic composition is water or an aqueous solution. In some embodiments, the hydrophilic composition is delivered to the through hole created by an opening on the top surface that extends to the bottom surface. In some embodiments, the through hole opening on the top surface is not covered when delivering the hydrophilic composition.

As shown in FIGS. 3B and 3C, the through hole along with the substantially impervious seal 318 between the bottom surface and corresponding surface on the substrate provides a space or sample well 310 for the delivery of a hydrophilic composition 312. Hydrophilic compositions may be added to the sample well without the risk of losing any hydrophilic composition to leakage underneath the adapter due to the secure seal provided by the bottom surface and substrate.

In some embodiments, the bottom surface of the adapter and/or its corresponding surface on the substrate is adhesive. In some embodiments, the bottom surface of the adapter and its corresponding surface on the substrate are bonded by an adhesive material. In some embodiments, the adapter is applied to the substrate via an adhesive material on its bottom surface, optionally the adhesive material is in the form of a double-side tape. In some embodiments, the bottom surface is removable from the substrate.

In some embodiments, the adapter is not secured to the substrate by any physical device and/or structure or sandwiched between the substrate and any physical device and/or structure. Such physical devices and/or structures may include but are not limited to a clip, a clamp, or a sample cassette. In some embodiments, the adapter is not secured to the substrate by any physical device and/or structure, optionally wherein the adapter is not secured to the substrate by a clip or clamp. In some embodiments, the adaptor is not secured to the substrate by a clip or clamp.

In some embodiments, provided herein is a method further comprising allowing a reaction between a molecule in the region of interest and one or more agents in the hydrophilic composition. In some embodiments, hydrophilic composition may comprise one or more buffer, enzyme, chemical, probe, and/or other reagent required for biological sample analysis (e.g., in situ analysis). In some embodiments, the reagents can be any as used for sample preparation, sample characterization, detection and/or analysis. In some embodiments, the reagents can be any as used for sample preparation, detection, and analysis as described in Sections III and IV. In some embodiments, a hydrophilic composition as described herein may comprise one or more reagents for sample processing, including but not limited to disaggregation, permeabilizing, staining, crosslinking, de-crosslinking, etc. In other embodiments, a hydrophilic comprise one or more reagents for sample analysis, including but not limited to stripping agents, washing buffers, quenching reagents, probes (e.g., nucleic acid probes), imaging buffers, etc. In some embodiments, wherein one or more hydrophilic compositions are delivered, the one or more hydrophilic compositions may comprise the same reagents or may comprise different reagents. In some embodiments, wherein one or more hydrophilic compositions are delivered, the one or more hydrophilic compositions may be delivered in combination or in sequence (e.g., after removal of a previous hydrophilic composition). In some embodiments, one or more of the hydrophilic compositions are delivered to the sample in the through hole via a pipette or a dispenser.

In any of the preceding embodiments, the method further comprises detecting a signal associated with the reaction or a product thereof, thereby detecting the molecule in situ in the biological sample. With reference to FIGS. 3C-3D, step 307, in some embodiments, detection of a signal is enabled by dipping an objective of a microscope in the hydrophilic composition. As shown in FIG. 3D, the dipping objective 314 is lowered to the surface 316 of the hydrophilic composition to facilitate biological sample imaging and/or analysis.

In any of the preceding embodiments, the method further comprises removing the hydrophilic composition after the reaction from the through hole through its opening on the top surface. As seen in FIGS. 3B-3D, through hole access is preserved in the absence of a cover, allowing for sequential addition and removal of hydrophilic compositions to the space surrounding the biological sample and region of interest in the sample.

In any of the preceding embodiments, the method further comprises delivering another hydrophilic composition to cover the region of interest and repeating steps of allowing a reaction between a molecule in the region of interest and one or more agents in the hydrophilic composition, detecting a signal associated with the reaction or a product thereof, and removing the hydrophilic composition in one or more sequential cycles. As seen in FIGS. 3B-3D, through hole access is preserved in the absence of a cover, allowing for sequential addition and removal of hydrophilic compositions 312 to the space 310 surrounding the biological sample 302. In some embodiments, the one or more sequential cycles of hydrophilic composition exposure (e.g., addition followed by removal) is required for complex biological analysis (e.g., in situ analysis).

In any of the preceding embodiments, one or more steps of the method are automated (e.g., allowing a reaction between a molecule in the region of interest and one or more agents in the hydrophilic composition, detecting a signal associated with the reaction or a product thereof, removing the hydrophilic composition, and delivering another hydrophilic composition). In some embodiments, the adapter is compatible with an assay that includes both one or more manual steps for delivering a hydrophilic composition (e.g., via a pipette) and one or more automated steps for delivering a hydrophilic composition. As seen in FIG. 1, the presence of one or more positional markers and/or fiducial markers 104, as well as one or more one or two dimensional barcodes 108, on the adapter 100 enables analytical instrument and/or computer automation of one or more steps of the method described herein (e.g., sample orientation, hydrophilic composition addition or removal, sample imaging, sample analysis).

In any of the preceding embodiments, the adapter comprises one or more barcodes, optionally a one-dimensional barcode and/or a two-dimensional barcode, optionally wherein the two-dimensional barcode is a QR code. In any of the embodiments herein, the adaptor can comprise one or more one-dimensional and/or two-dimensional barcodes. In any of the embodiments herein, the adaptor can comprise one or more two-dimensional barcodes that are QR codes. In any of the preceding embodiments, the one or more positional markers and/or fiducial markers and/or the one or more barcodes are configured to be recognized by a microscope, optionally wherein the microscope is a fluorescence microscope, and/or a computer, optionally wherein the computer is used for sample alignment, image acquisition, and/or image analysis. In any of the embodiments herein, the microscope can be a fluorescence microscope. In any of the embodiments herein, the computer can be used for sample alignment and image analysis. In any of the preceding embodiments, the microscope and/or computer is automated to recognize the one or more positional markers and/or fiducial markers and/or the one or more barcodes. In any of the preceding embodiments, the delivery of the hydrophilic composition to cover the region of interest is automated according to information extracted by the microscope and/or computer from the one or more positional markers and/or fiducial markers and/or the one or more barcodes. In any of the preceding embodiments, imaging of the region of interest is automated according to information extracted by the microscope and/or computer from the one or more positional markers and/or fiducial markers and/or the one or more barcodes.

### III. Samples and Sample Processing

### A. Samples

A sample disclosed herein can be or derived from any biological sample. Methods and compositions disclosed herein may be used for analyzing a biological sample, which may be obtained from a subject using any of a variety of techniques including, but not limited to, biopsy, surgery, and laser capture microscopy (LCM), and generally includes cells and/or other biological material from the subject. In addition to the subjects described above, a biological sample can be obtained from a prokaryote such as a bacterium, an archaea, a virus, or a viroid. A biological sample can also be obtained from non-mammalian organisms (e.g., a plant, an insect, an arachnid, a nematode, a fungus, or an amphibian). A biological sample can also be obtained from a eukaryote, such as a tissue sample, a patient derived organoid (PDO) or patient derived xenograft (PDX). A biological sample from an organism may comprise one or more other organisms or components therefrom. For example, a mammalian tissue section may comprise a prion, a viroid, a virus, a bacterium, a fungus, or components from other organisms, in addition to mammalian cells and non-cellular tissue components. Subjects from which biological samples can be obtained can be healthy or asymptomatic individuals, individuals that have or are suspected of having a disease (e.g., a patient with a disease such as cancer) or a pre-disposition to a disease, and/or individuals in need of therapy or suspected of needing therapy.

The biological sample can include any number of macromolecules, for example, cellular macromolecules and organelles (e.g., mitochondria and nuclei). The biological sample can be a nucleic acid sample and/or protein sample. The biological sample can be a carbohydrate sample or a lipid sample. The biological sample can be obtained as a tissue sample, such as a tissue section, biopsy, a core biopsy, needle aspirate, or fine needle aspirate. The sample can be a fluid sample, such as a blood sample, urine sample, or saliva sample. The sample can be a skin sample, a colon sample, a cheek swab, a histology sample, a histopathology sample, a plasma or serum sample, a tumor sample, living cells, cultured cells, a clinical sample such as, for example, whole blood or blood-derived products, blood cells, or cultured tissues or cells, including cell suspensions. In some embodiments, the biological sample may comprise cells which are deposited on a surface.

The thickness of the tissue section can be a fraction of (e.g., less than 0.9, 0.8, 0.7, 0.6, 0.5, 0.4, 0.3, 0.2, or 0.1) the maximum cross-sectional dimension of a cell. However, tissue sections having a thickness that is larger than the maximum cross-section cell dimension can also be used. For example, cryostat sections can be used, which can be, e.g., 10-20 µm thick.

More generally, the thickness of a tissue section typically depends on the method used to prepare the section and the physical characteristics of the tissue, and therefore sections having a wide variety of different thicknesses can be prepared and used. For example, the thickness of the tissue section can be at least 0.1, 0.2, 0.3, 0.4, 0.5, 0.7, 1.0, 1.5, 2, 3, 4, 5, 6, 7, 8, 9, 10, 12, 13, 14, 15, 20, 30, 40, or 50 µm. Thicker sections can also be used if desired or convenient, e.g., about 55, about 60, about 65, about 70, about 75, about 80, about 85, about 90, about 100 µm or more. Typically, the thickness of a tissue section is between 1-100 µm, 1-50 µm, 1-30 µm, 1-25 µm, 1-20 µm, 1-15 µm, 1-10 µm, 2-8 µm, 3-7 µm, or 4-6 µm, but as mentioned above, sections with thicknesses larger or smaller than these ranges can also be analyzed. In some embodiments, the biological sample is a tissue slice between about 1 µm and about 50 µm in thickness, optionally wherein the tissue slice is between about 5 µm and about 35 µm in thickness. In some embodiments, the biological sample is a tissue slice between about 5 µm and about 35 µm in thickness In some embodiments, the biological sample is a tissue slice about 5 µm, about 10 µm, about 15 µm, about 20 µm, about 25 µm, about 30 µm, about 35 µm, about 40 µm, about 45 µm, or about 50 µm in thickness.

Cell-free biological samples can include extracellular polynucleotides. Extracellular polynucleotides can be isolated from a bodily sample, e.g., blood, plasma, serum, urine, saliva, mucosal excretions, sputum, stool, and tears.

Biological samples can be derived from a homogeneous culture or population of the subjects or organisms mentioned herein or alternatively from a collection of several different organisms, for example, in a community or ecosystem.

Biological samples can include one or more diseased cells. A diseased cell can have altered metabolic properties, gene expression, protein expression, and/or morphologic features. Examples of diseases include inflammatory disorders, metabolic disorders, nervous system disorders, and cancer. Cancer cells can be derived from solid tumors, hematological malignancies, cell lines, or obtained as circulating tumor cells.

Biological samples can also include fetal cells. For example, a procedure such as amniocentesis can be performed to obtain a fetal cell sample from maternal circulation. Sequencing of fetal cells can be used to identify any of a number of genetic disorders, including, e.g., aneuploidy such as Down’s syndrome, Edwards syndrome, and Patau syndrome. Further, cell surface features of fetal cells can be used to identify any of a number of disorders or diseases.

Biological samples can also include immune cells. Sequence analysis of the immune repertoire of such cells, including genomic, proteomic, and cell surface features, can provide a wealth of information to facilitate an understanding the status and function of the immune system. By way of example, determining the status (e.g., negative or positive) of minimal residue disease (MRD) in a multiple myeloma (MM) patient following autologous stem cell transplantation is considered a predictor of MRD in the MM patient (see, e.g., U.S. Pat. Application Publication No. 2018/0156784, the entire contents of which are incorporated herein by reference).

Examples of immune cells in a biological sample include, but are not limited to, B cells, T cells (e.g., cytotoxic T cells, natural killer T cells, regulatory T cells, and T helper cells), natural killer cells, cytokine induced killer (CIK) cells, myeloid cells, such as granulocytes (basophil granulocytes, eosinophil granulocytes, neutrophil granulocytes/hypersegmented neutrophils), monocytes/macrophages, mast cells, thrombocytes/megakaryocytes, and dendritic cells.

Biological samples can include analytes (e.g., protein, RNA, and/or DNA) embedded in a 3D matrix. In some embodiments, amplicons (e.g., rolling circle amplification products) derived from or associated with analytes (e.g., protein, RNA, and/or DNA) can be embedded in a 3D matrix. In some embodiments, a 3D matrix may comprise a network of natural molecules and/or synthetic molecules that are chemically and/or enzymatically linked, e.g., by crosslinking. In some embodiments, a 3D matrix may comprise a synthetic polymer. In some embodiments, a 3D matrix comprises a hydrogel.

In some embodiments, a substrate herein can be any support that is insoluble in aqueous liquid and which allows for positioning of biological samples, analytes, features, and/or reagents (e.g., probes) on the support. In some embodiments, a biological sample can be attached to a substrate. Attachment of the biological sample can be irreversible or reversible, depending upon the nature of the sample and subsequent steps in the analytical method. In certain embodiments, the sample can be attached to the substrate reversibly by applying a suitable polymer coating to the substrate, and contacting the sample to the polymer coating. The sample can then be detached from the substrate, e.g., using an organic solvent that at least partially dissolves the polymer coating. Hydrogels are examples of polymers that are suitable for this purpose.

In some embodiments, the substrate can be coated or functionalized with one or more substances to facilitate attachment of the sample to the substrate. Suitable substances that can be used to coat or functionalize the substrate include, but are not limited to, lectins, poly-lysine, antibodies, and polysaccharides.

A variety of steps can be performed to prepare or process a biological sample for and/or during an assay. Except where indicated otherwise, the preparative or processing steps described below can generally be combined in any manner and in any order to appropriately prepare or process a particular sample for and/or analysis.

### B. Sample Processing

In some embodiments, the methods provided herein for processing a biological sample may further comprise additional steps to obtain and/or prepare the biological samples both prior to applying an adapter described herein and after applying the adapter, as part of the methods described herein. It should be recognized that the biological samples as provided herein may be subjected to various processing steps, the combinations of which are used to obtain and applied to each biological sample may vary depending upon the type of biological sample, the source of the biological sample and the intended analytical method for the biological sample, among others. Relevant processing steps may include but are not limited to tissue sectioning, freezing, fixation and post-fixation, permeabilizing, staining, expansion, cross-linking, de-cross-linking, and/or clearing.

In some embodiments, the methods provided herein for applying an adapter may further comprise additional steps to prepare the biological samples after applying an adapter. As with pre-processing steps applied to the biological samples, it should be recognized that the biological samples as provided herein may be subjected to various processing steps, the combinations of which are used to applied to each biological sample may vary depending upon the type of biological sample, the source of the biological sample and the intended analytical method for the biological sample, among others. Relevant processing steps may include but are not limited to fixation and post-fixation, permeabilizing, staining, expansion, cross-linking, de-cross-linking, and/or clearing.

### (I) Tissue Sectioning

In some embodiments, the method further comprises obtaining a biological sample to be processed and/or analyzed.

A biological sample can be harvested from a subject (e.g., via surgical biopsy, whole subject sectioning) or grown in vitro on a growth substrate or culture dish as a population of cells, and prepared for analysis as a tissue slice or tissue section. Grown samples may be sufficiently thin for analysis without further processing steps. Alternatively, grown samples, and samples obtained via biopsy or sectioning, can be prepared as thin tissue sections using a mechanical cutting apparatus such as a vibrating blade microtome. As another alternative, in some embodiments, a thin tissue section can be prepared by applying a touch imprint of a biological sample to a suitable substrate material.

The thickness of the tissue section can be a fraction of (e.g., less than 0.9, 0.8, 0.7, 0.6, 0.5, 0.4, 0.3, 0.2, or 0.1) the maximum cross-sectional dimension of a cell. However, tissue sections having a thickness that is larger than the maximum cross-section cell dimension can also be used. For example, cryostat sections can be used, which can be, e.g., 10-20 µm thick.

More generally, the thickness of a tissue section typically depends on the method used to prepare the section and the physical characteristics of the tissue, and therefore sections having a wide variety of different thicknesses can be prepared and used. For example, the thickness of the tissue section can be at least 0.1, 0.2, 0.3, 0.4, 0.5, 0.7, 1.0, 1.5, 2, 3, 4, 5, 6, 7, 8, 9, 10, 12, 13, 14, 15, 20, 30, 40, or 50 µm. Thicker sections can also be used if desired or convenient, e.g., at least 70, 80, 90, or 100 µm or more. Typically, the thickness of a tissue section is between 1-100 µm, 1-50 µm, 1-30 µm, 1-25 µm, 1-20 µm, 1-15 µm, 1-10 µm, 2-8 µm, 3-7 µm, or 4-6 µm, but as mentioned above, sections with thicknesses larger or smaller than these ranges can also be analysed.

Multiple sections can also be obtained from a single biological sample. For example, multiple tissue sections can be obtained from a surgical biopsy sample by performing serial sectioning of the biopsy sample using a sectioning blade. Spatial information among the serial sections can be preserved in this manner, and the sections can be analysed successively to obtain three-dimensional information about the biological sample.

### (II) Freezing

In some embodiments, the biological sample (e.g., a tissue section as described above) can be prepared by deep freezing at a temperature suitable to maintain or preserve the integrity (e.g., the physical characteristics) of the tissue structure. Such a temperature can be, e.g., less than -20° C., or less than -25° C., -30° C., -40° C., -50° C., -60° C., -70° C., -80° C. -90° C., -100° C., -110° C., -120° C., -130° C., -140° C., -150° C., -160° C., -170° C., -180° C., -190° C., or -200° C. The frozen tissue sample can be sectioned, e.g., thinly sliced, onto a substrate surface using any number of suitable methods. For example, a tissue sample can be prepared using a chilled microtome (e.g., a cryostat) set at a temperature suitable to maintain both the structural integrity of the tissue sample and the chemical properties of the nucleic acids in the sample. Such a temperature can be, e.g., less than -15° C., less than -20° C., or less than -25° C.

### (III) Fixation and Postfixation

In some embodiments, the method comprises fixing the biological sample prior to application of the adapter to fully enable in situ analysis.

In some embodiments, the biological sample can be prepared using formalin-fixation and paraffin-embedding (FFPE), which are established methods. In some embodiments, cell suspensions and other non-tissue samples can be prepared using formalin-fixation and paraffin-embedding. Following fixation of the sample and embedding in a paraffin or resin block, the sample can be sectioned as described above. Prior to analysis, the paraffin-embedding material can be removed from the tissue section (e.g., deparaffinization) by incubating the tissue section in an appropriate solvent (e.g., xylene) followed by a rinse (e.g., 99.5% ethanol for 2 minutes, 96% ethanol for 2 minutes, and 70% ethanol for 2 minutes).

As an alternative to formalin fixation described above, a biological sample can be fixed in any of a variety of other fixatives to preserve the biological structure of the sample prior to analysis. For example, a sample can be fixed via immersion in ethanol, methanol, acetone, paraformaldehyde (PFA)-Triton, and combinations thereof.

In some embodiments, acetone fixation is used with fresh frozen samples, which can include, but are not limited to, cortex tissue, mouse olfactory bulb, human brain tumor, human post-mortem brain, and breast cancer samples. When acetone fixation is performed, pre-permeabilization steps (described below) may not be performed. Alternatively, acetone fixation can be performed in conjunction with permeabilization steps.

In some embodiments, the methods provided herein comprises one or more post-fixing (also referred to as postfixation) steps. In some embodiments, one or more post-fixing step is performed after contacting a sample with a polynucleotide disclosed herein, e.g., one or more probes such as a circular or circularizable probe or probe set (e.g., padlock probe). In some embodiments, one or more post-fixing step is performed after a hybridization complex comprising a probe and a target is formed in a sample. In some embodiments, one or more post-fixing step is performed prior to a ligation reaction disclosed herein, such as the ligation to circularize a circularizable probe or probe set (e.g., padlock probe).

In some embodiments, one or more post-fixing step is performed after contacting a sample with a binding or labelling agent (e.g., an antibody or antigen binding fragment thereof) for a non-nucleic acid analyte such as a protein analyte. The labelling agent can comprise a nucleic acid molecule (e.g., reporter oligonucleotide) comprising a sequence corresponding to the labelling agent and therefore corresponds to (e.g., uniquely identifies) the analyte. In some embodiments, the labelling agent can comprise a reporter oligonucleotide comprising one or more barcode sequences.

A post-fixing step may be performed using any suitable fixation reagent disclosed herein, for example, 3% (w/v) paraformaldehyde in DEPC-PBS.

### (IV) Disaggregation of Cells

In some embodiments, the biological sample corresponds to cells (e.g., derived from a cell culture, a tissue sample, or cells deposited on a surface). In a cell sample with a plurality of cells, individual cells can be naturally unaggregated. For example, the cells can be derived from a suspension of cells and/or disassociated or disaggregated cells from a tissue or tissue section.

Alternatively, the cells in the sample may be aggregated, and may be disaggregated into individual cells using, for example, enzymatic or mechanical techniques. Examples of enzymes used in enzymatic disaggregation include, but are not limited to, dispase, collagenase, trypsin, and combinations thereof. Mechanical disaggregation can be performed, for example, using a tissue homogenizer. The biological sample may comprise disaggregated cells (e.g., nonadherent or suspended cells) which are deposited on a surface and subjected to an in situ assay.

### (V) Tissue Permeabilization and Treatment

In some embodiments, the method comprises permeabilizing the biological sample prior to the application of the adapter to the unmodified substrate and the biological sample immobilized on the substrate. In some embodiments, the method comprises permeabilizing the biological sample after the fixing step and prior to the application of the adapter to the substrate.

In some embodiments, a biological sample can be permeabilized to facilitate transfer of analytes out of the sample, and/or to facilitate transfer of species (such as probes) into the sample. If a sample is not permeabilized sufficiently, the amount of analyte captured from the sample may be too low to enable adequate analysis. Conversely, if the tissue sample is too permeable, the relative spatial relationship of the analytes within the tissue sample can be lost. Hence, a balance between permeabilizing the tissue sample enough to obtain good signal intensity while still maintaining the spatial resolution of the analyte distribution in the sample is desirable.

In general, a biological sample can be permeabilized by exposing the sample to one or more permeabilizing agents. Suitable agents for this purpose include, but are not limited to, organic solvents (e.g., acetone, ethanol, and methanol), cross-linking agents (e.g., paraformaldehyde), detergents (e.g., saponin, Triton X-100™ or Tween-20™), and enzymes (e.g., trypsin, proteases). In some embodiments, the biological sample can be incubated with a cellular permeabilizing agent to facilitate permeabilization of the sample. Additional methods for sample permeabilization are described, for example, in Jamur et al., Method Mol. Biol. 588:63-66, 2010, the entire contents of which are incorporated herein by reference. Any suitable method for sample permeabilization can generally be used in connection with the samples described herein.

In some embodiments, the biological sample can be permeabilized by adding one or more lysis reagents to the sample. Examples of suitable lysis agents include, but are not limited to, bioactive reagents such as lysis enzymes that are used for lysis of different cell types, e.g., gram positive or negative bacteria, plants, yeast, mammalian, such as lysozymes, achromopeptidase, lysostaphin, labiase, kitalase, lyticase, and a variety of other commercially available lysis enzymes.

Other lysis agents can additionally or alternatively be added to the biological sample to facilitate permeabilization. For example, surfactant-based lysis solutions can be used to lyse sample cells. Lysis solutions can include ionic surfactants such as, for example, sarcosyl and sodium dodecyl sulfate (SDS). More generally, chemical lysis agents can include, without limitation, organic solvents, chelating agents, detergents, surfactants, and chaotropic agents.

In some embodiments, the biological sample can be permeabilized by non-chemical permeabilization methods. For example, non-chemical permeabilization methods that can be used include, but are not limited to, physical lysis techniques such as electroporation, mechanical permeabilization methods (e.g., bead beating using a homogenizer and grinding balls to mechanically disrupt sample tissue structures), acoustic permeabilization (e.g., sonication), and thermal lysis techniques such as heating to induce thermal permeabilization of the sample.

Additional reagents can be added to a biological sample to perform various functions prior to analysis of the sample. In some embodiments, DNase and RNase inactivating agents or inhibitors such as proteinase K, and/or chelating agents such as EDTA, can be added to the sample. For example, a method disclosed herein may comprise a step for increasing accessibility of a nucleic acid for binding, e.g., a denaturation step to opening up DNA in a cell for hybridization by a probe. For example, proteinase K treatment may be used to free up DNA with proteins bound thereto.

### (VI) Staining and Immunohistochemistry (IHC)

In some embodiments, the method comprises staining the biological sample prior to or after sample analysis (e.g., in situ analysis). When paired together with in situ analysis, sample staining can provide orthogonal diagnostic information for additional sample analysis. In some embodiments of the methods herein, the methods enable sample staining (e.g., hematoxylin and eosin (H&E) staining) prior to in situ analysis. In some embodiments of the methods herein, the methods enable sample staining (e.g., hematoxylin and eosin (H&E) staining) post in situ analysis.

In some embodiments, the method comprises staining the biological sample, wherein staining occurs after application of the adapter, and after one or more rounds of in situ analysis and/or signal detection, wherein the adapter is optionally removed prior to staining. In some embodiments, the method comprises staining the biological sample prior to the application of the adapter to the substrate and the biological sample immobilized on the substrate. In other embodiments, the method comprises staining the biological sample after the fixing step and prior to the application of the adapter to the substrate. In some embodiments, the method comprises staining the biological sample, wherein staining occurs after application of the adapter, one or more rounds of in situ analysis and/or signal detection, and wherein the adapter is removed from the substrate to enable subsequent staining of the biological sample. In other embodiments, the method comprises staining the biological sample, wherein staining occurs after application of the adapter, one or more rounds of in situ analysis and/or signal detection, and wherein the adapter is not removed, the biological sample is stained, and a cover (e.g., a coverslip) is applied. In further embodiments, the method comprises staining the biological sample, wherein staining occurs after application of the adapter, one or more rounds of in situ analysis and/or signal detection, and wherein the adapter is either removed or not removed to enable sample staining and subsequent sample visualization. In some embodiments, application of the adapter enables the sample to be stained, and optionally wherein a cover slip may be applied to cover the sample during and/or after the staining. In some embodiments, application of the adapter enables the sample to be stained, and wherein a cover slip may be applied to cover the sample during and/or after the staining. In further embodiments, the adapter can be removable and the method comprises staining the biological sample after removal of the adapter from the substrate.

To facilitate visualization, biological samples can be stained using a wide variety of stains and staining techniques. In some embodiments, for example, a sample can be stained using any number of stains and/or immunohistochemical reagents. One or more staining steps may be performed to prepare or process a biological sample for an assay described herein or may be performed during and/or after an assay. In some embodiments, the sample can be contacted with one or more nucleic acid stains, membrane stains (e.g., cellular or nuclear membrane), cytological stains, or combinations thereof. In some examples, the stain may be specific to proteins, phospholipids, DNA (e.g., dsDNA, ssDNA), RNA, an organelle or compartment of the cell. The sample may be contacted with one or more labeled antibodies (e.g., a primary antibody specific for the analyte of interest and a labeled secondary antibody specific for the primary antibody). In some embodiments, cells in the sample can be segmented using one or more images taken of the stained sample.

In some embodiments, the stain is performed using a lipophilic dye. In some examples, the staining is performed with a lipophilic carbocyanine or aminostyryl dye, or analogs thereof (e.g, DiI, DiO, DiR, DiD). Other cell membrane stains may include FM and RH dyes or immunohistochemical reagents specific for cell membrane proteins. In some examples, the stain may include, but not limited to, acridine orange, Bismarck brown, carmine, coomassie blue, cresyl violet, DAPI, eosin, ethidium bromide, acid fuchsine, haematoxylin, Hoechst stains, iodine, methyl green, methylene blue, neutral red, Nile blue, Nile red, osmium tetroxide, ruthenium red, propidium iodide, rhodamine (e.g., rhodamine B), or safranine or derivatives thereof. In some embodiments, the sample may be stained with haematoxylin and eosin (H&E).

The sample can be stained using hematoxylin and eosin (H&E) staining techniques, using Papanicolaou staining techniques, Masson’s trichrome staining techniques, silver staining techniques, Sudan staining techniques, and/or using Periodic Acid Schiff (PAS) staining techniques. PAS staining is typically performed after formalin or acetone fixation. In some embodiments, the sample can be stained using Romanowsky stain, including Wright’s stain, Jenner’s stain, Can-Grunwald stain, Leishman stain, and Giemsa stain.

In some embodiments, biological samples can be destained. Any suitable methods of destaining or discoloring a biological sample may be utilized, and generally depend on the nature of the stain(s) applied to the sample. For example, in some embodiments, one or more immunofluorescent stains are applied to the sample via antibody coupling. Such stains can be removed using techniques such as cleavage of disulfide linkages via treatment with a reducing agent and detergent washing, chaotropic salt treatment, treatment with antigen retrieval solution, and treatment with an acidic glycine buffer. Methods for multiplexed staining and destaining are described, for example, in Bolognesi et al., J. Histochem. Cytochem. 2017; 65(8): 431-444, Lin et al., Nat Commun. 2015; 6:8390, Pirici et al., J. Histochem. Cytochem. 2009; 57:567-75, and Glass et al., J. Histochem. Cytochem. 2009; 57:899-905, the entire contents of each of which are incorporated herein by reference.

### (VII) Isometric Expansion

In some embodiments, the matrix-forming material comprises a plurality of stimulus-responsive matrix-forming monomers and wherein the first three-dimensional polymerized matrix expands when exposed to a suitable stimulus, optionally wherein the stimulus-responsive matrix-forming monomers comprise a sodium acrylate monomer and/or an N-isopropylacrylamide/acrylamide monomer. In some embodiments, the stimulus-responsive matrix-forming monomers comprise a sodium acrylate monomer and/or an N-isopropylacrylamide/acrylamide monomer. In some embodiments, the plurality of stimulus-responsive matrix-forming monomers comprises acrylic acid and acrylamide monomers, or N-isopropylacrylamide and acrylamide monomers. In some embodiments, the methods provided herein comprise expanding the biological sample embedded in the (first) three-dimensional polymerized matrix. In some embodiments, the expanding step comprises subjecting the first three-dimensional polymerized matrix to a change in salt concentration or a temperature change.

In some embodiments, a biological sample embedded in a matrix (a hydrogel) can be isometrically expanded. Isometric expansion methods that can be used include hydration, a preparative step in expansion microscopy, as described in Chen et al., Science 347(6221):543-548, 2015, which is herein incorporated in its entirety.

Isometric expansion can be performed by anchoring one or more components of a biological sample to a gel, followed by gel formation, proteolysis, and swelling. In some embodiments, analytes in the sample, products of the analytes, and/or probes associated with analytes in the sample can be anchored to the matrix (e.g., hydrogel). Isometric expansion of the biological sample can occur prior to immobilization of the biological sample on a substrate, or after the biological sample is immobilized to a substrate. In some embodiments, the isometrically expanded biological sample can be removed from the substrate prior to contacting the substrate with probes disclosed herein.

In general, the steps used to perform isometric expansion of the biological sample can depend on the characteristics of the sample (e.g., thickness of tissue section, fixation, cross-linking), and/or the analyte of interest (e.g., different conditions to anchor RNA, DNA, and protein to a gel).

In some embodiments, proteins in the biological sample are anchored to a swellable gel such as a polyelectrolyte gel. An antibody can be directed to the protein before, after, or in conjunction with being anchored to the swellable gel. DNA and/or RNA in a biological sample can also be anchored to the swellable gel via a suitable linker. Examples of such linkers include, but are not limited to, 6-((Acryloyl)amino) hexanoic acid (Acryloyl-X SE) (available from ThermoFisher, Waltham, MA), Label-IT Amine (available from MirusBio, Madison, WI) and Label X (described for example in Chen et al., Nat. Methods 13:679-684, 2016, the entire contents of which are incorporated herein by reference).

Isometric expansion of the sample can increase the spatial resolution of the subsequent analysis of the sample. The increased resolution in spatial profiling can be determined by comparison of an isometrically expanded sample with a sample that has not been isometrically expanded.

In some embodiments, a biological sample is isometrically expanded to a size at least 2×, 2.1×, 2.2×, 2.3×, 2.4×, 2.5×, 2.6×, 2.7×, 2.8×, 2.9×, 3×, 3.1×, 3.2×, 3.3×, 3.4×, 3.5×, 3.6×, 3.7×, 3.8×, 3.9×, 4×, 4.1×, 4.2×, 4.3×, 4.4×, 4.5×, 4.6×, 4.7×, 4.8×, or 4.9× its non-expanded size. In some embodiments, the sample is isometrically expanded to at least 2× and less than 20× of its non-expanded size.

### IV. Detection and Analysis

In some embodiments, the biological samples prepared according to the methods provided herein may be subjected to further characterization, analyte detection and/or analysis.

### A. In Situ Analysis

In some aspects, the provided embodiments of biological samples and the substrate to which the biological samples are immobilized and which are further fitted with the adapters provided herein can be employed as samples in an in situ method of analyzing nucleic acid sequences, such as in situ hybridization and/or in situ sequencing, for example from intact tissues or samples in which the spatial information has been preserved. In some aspects, the embodiments can be applied in an imaging or detection method for multiplexed nucleic acid analysis. Exemplary in situ methods include sequential fluorescent in situ hybridization (e.g., MERFISH, SeqFISH, etc.), ligation-based in situ sequencing (e.g., Sequencing by Dynamic Annealing and Ligation (SEDAL) as described in WO 2019/199579, the content of which is herein incorporated by reference in its entirety), and hybridization-based in situ sequencing (HybISS) (e.g., as described in US 2021/0340618, the content of which is herein incorporated by reference in its entirety) or a combination thereof. In some aspects, the provided embodiments can be used to identify or detect single nucleotides of interest in target nucleic acids.

In some aspects, the embodiments can be applied in investigative and/or diagnostic applications, for example, for characterization or assessment of particular cell or a tissue from a subject. Applications of the provided method can comprise biomedical research and clinical diagnostics. For example, in biomedical research, applications comprise, but are not limited to, spatially resolved gene expression analysis for biological investigation or drug screening. In clinical diagnostics, applications comprise, but are not limited to, detecting gene markers such as disease, immune responses, bacterial or viral DNA/RNA for patient samples. In some aspects, the embodiments can be applied to visualize the distribution of genetically encoded markers in whole tissue at subcellular resolution.

In some aspects, the provided herein are methods for analyzing, e.g., detecting or determining, the presence of one or more analytes in the biological sample processed according to the methods described herein. In some aspects, an analyte disclosed herein can include any biological substance, structure, moiety, or component to be analyzed. In some aspects, a target disclosed herein may similarly include any analyte of interest, such as a biomarker.

### (I) Analytes

Many different systems, apparatus, and methods have been described that can be used to analyze any number of analytes present in the biological samples of the present disclosure. For example, the number of analytes that are analyzed can be at least about 2, at least about 3, at least about 4, at least about 5, at least about 6, at least about 7, at least about 8, at least about 9, at least about 10, at least about 11, at least about 12, at least about 13, at least about 14, at least about 15, at least about 20, at least about 25, at least about 30, at least about 40, at least about 50, at least about 100, at least about 1,000, at least about 10,000, at least about 100,000 or more different analytes present in a region of the sample. In some embodiments, each analyte panel comprises 1, 2, 3, 4, 5, 6, 7, 8, 9, 10, or more analytes (e.g., biomarkers). In some embodiments, any one or more of the analyte panels can comprise about 1, about 5, about 10, about 25, about 50, about 100, about 250, about 500, about 1,000, about 2,500, about 5,000 or more analytes (e.g., biomarkers).

Analytes can be derived from a specific type of cell and/or a specific sub-cellular region. For example, analytes can be derived from cytosol, from cell nuclei, from mitochondria, from microsomes, and more generally, from any other compartment, organelle, or portion of a cell. Permeabilizing agents that specifically target certain cell compartments and organelles can be used to selectively release analytes from cells for analysis, and/or allow access of one or more reagents (e.g., probes for in situ analysis) to the analytes in the cell or cell compartment or organelle.

Analytes can be broadly classified into one of two groups: nucleic acid analytes, and non-nucleic acid analytes. A method disclosed herein can be used to analyze nucleic acid analytes and/or non-nucleic acid analytes in any suitable combination.

Examples of nucleic acid analytes include DNA analytes such as genomic DNA, methylated DNA, specific methylated DNA sequences, fragmented DNA, mitochondrial DNA, in situ synthesized PCR products, and RNA/DNA hybrids.

Examples of nucleic acid analytes also include RNA analytes such as various types of coding and non-coding RNA. Examples of a non-coding RNAs (ncRNA) that is not translated into a protein include transfer RNAs (tRNAs) and ribosomal RNAs (rRNAs), as well as small non-coding RNAs such as microRNA (miRNA), small interfering RNA (siRNA), Piwi-interacting RNA (piRNA), small nucleolar RNA (snoRNA), small nuclear RNA (snRNA), extracellular RNA (exRNA), small Cajal body-specific RNAs (scaRNAs), and the long ncRNAs such as Xist and HOTAIR. Examples of the different types of RNA analytes include messenger RNA (mRNA), including a nascent RNA, a pre-mRNA, a primary-transcript RNA, and a processed RNA, such as a capped mRNA (e.g., with a 5′ 7-methyl guanosine cap), a polyadenylated mRNA (poly-A tail at the 3′ end), and a spliced mRNA in which one or more introns have been removed. Also included in the analytes disclosed herein are non-capped mRNA, a non-polyadenylated mRNA, and a non-spliced mRNA. Additional examples of RNA analytes include rRNA, tRNA, miRNA, and viral RNA. The RNA can be a transcript (e.g., present in a tissue section). The RNA can be small (e.g., less than 200 nucleic acid bases in length) or large (e.g., RNA greater than 200 nucleic acid bases in length). Examples of small RNAs include 5.8S ribosomal RNA (rRNA), 5S rRNA, tRNA, miRNA, siRNA, snoRNAs, piRNA, tRNA-derived small RNA (tsRNA), and small rDNA-derived RNA (srRNA). The RNA can be double-stranded RNA or single-stranded RNA. The RNA can be circular RNA. The RNA can be a bacterial rRNA (e.g., 16 s rRNA or 23 s rRNA).

In any of the embodiments herein, the method can comprise analyzing one or more non-nucleic acid analytes, such as protein analytes. In some embodiments, each non-nucleic acid analyte is linked to a labelling agent, e.g., an antibody or antigen binding fragment thereof linked to a reporter oligonucleotide.

Examples of non-nucleic acid analytes include, but are not limited to, lipids, carbohydrates, peptides, proteins, glycoproteins (N-linked or O-linked), lipoproteins, phosphoproteins, specific phosphorylated or acetylated variants of proteins, amidation variants of proteins, hydroxylation variants of proteins, methylation variants of proteins, ubiquitylation variants of proteins, sulfation variants of proteins, viral coat proteins, extracellular and intracellular proteins, antibodies, and antigen binding fragments. In some embodiments, the analyte is inside a cell or on a cell surface, such as a transmembrane analyte or one that is attached to the cell membrane. In some embodiments, the analyte can be an organelle (e.g., nuclei or mitochondria). In some embodiments, the analyte is an extracellular analyte, such as a secreted analyte.

Cell surface features corresponding to analytes can include, but are not limited to, a receptor, an antigen, a surface protein, a transmembrane protein, a cluster of differentiation protein, a protein channel, a protein pump, a carrier protein, a phospholipid, a glycoprotein, a glycolipid, a cell-cell interaction protein complex, an antigen-presenting complex, a major histocompatibility complex, an engineered T-cell receptor, a T-cell receptor, a B-cell receptor, a chimeric antigen receptor, an extracellular matrix protein, a posttranslational modification (e.g., phosphorylation, glycosylation, ubiquitination, nitrosylation, methylation, acetylation or lipidation) state of a cell surface protein, a gap junction, and an adherens junction.

In certain embodiments, an analyte can be extracted from a live cell. Processing conditions can be adjusted to ensure that a biological sample remains live during analysis, and analytes are extracted from (or released from) live cells of the sample. Live cell-derived analytes can be obtained only once from the sample, or can be obtained at intervals from a sample that continues to remain in viable condition.

In certain embodiments, an analyte or a complex or product thereof may be immobilized in a sample, e.g., to one or more other molecules within the sample and/or within a matrix, generally at the location of the analyte within a native biological sample, e.g., under a physiological or pathological condition and/or while the sample is live. The analyte or a complex or product thereof may be immobilized within the sample and/or matrix by steric factors. The analyte or a complex or product thereof may also be immobilized within the sample and/or matrix by covalent or noncovalent bonding. In this manner, the analyte or a complex or product thereof may be considered to be attached to the sample or matrix. By being immobilized to the sample and/or matrix, such as by covalent bonding or cross-linking, the size and/or spatial relationship of the analyte or a complex or product thereof can be maintained. By being immobilized to the sample and/or matrix, such as by covalent bonding or cross-linking, the analyte or a complex or product thereof is resistant to movement or unraveling under mechanical stress.

### (II) Labelling Agents

In some embodiments, an analyte labelling agent (also referred to at times as a “capture agent”) may include an agent that interacts with an analyte (e.g., an analyte in a sample) and with a probe to identify the analyte. In some embodiments, the sample may be contacted with one or more labelling agents prior to, during, or after an in situ assay. In some embodiments, the method comprises one or more post-fixing (also referred to as post-fixation) steps after contacting the sample with one or more labelling agents. In some embodiments, the analyte labelling agent comprises an analyte binding moiety and a labelling agent barcode domain (e.g., an analyte binding moiety barcode).

In the methods and systems described herein, one or more labelling agents capable of binding to or otherwise coupling to one or more features may be used to characterize analytes, cells and/or cell features. In some instances, cell features include cell surface features. Analytes may include, but are not limited to, a protein, a receptor, an antigen, a surface protein, a transmembrane protein, a cluster of differentiation protein, a protein channel, a protein pump, a carrier protein, a phospholipid, a glycoprotein, a glycolipid, a cell-cell interaction protein complex, an antigen-presenting complex, a major histocompatibility complex, an engineered T-cell receptor, a T-cell receptor, a B-cell receptor, a chimeric antigen receptor, a gap junction, an adherens junction, or any combination thereof. In some instances, cell features may include intracellular analytes, such as proteins, protein modifications (e.g., phosphorylation status or other post-translational modifications), nuclear proteins, nuclear membrane proteins, or any combination thereof.

A labelling agent may include, but is not limited to, a protein, a peptide, an antibody (or an epitope binding fragment thereof), a lipophilic moiety (such as cholesterol), a cell surface receptor binding molecule, a receptor ligand, a small molecule, a bi-specific antibody, a bi-specific T-cell engager, a T-cell receptor engager, a B-cell receptor engager, a pro-body, an aptamer, a monobody, an affimer, a darpin, and a protein scaffold, or any combination thereof. The labelling agents can include (e.g., are attached to) a reporter oligonucleotide that is indicative of the cell surface feature to which the binding group binds. For example, the reporter oligonucleotide may comprise a barcode sequence that permits identification of the labelling agent. For example, a labelling agent that is specific to one type of cell feature (e.g., a first cell surface feature) may have coupled thereto a first reporter oligonucleotide, while a labelling agent that is specific to a different cell feature (e.g., a second cell surface feature) may have a different reporter oligonucleotide coupled thereto. For a description of exemplary labelling agents, reporter oligonucleotides, and methods of use, see, e.g., U.S. Pat. 10,550,429; U.S. Pat. Pub. 20190177800; and U.S. Pat. Pub. 20190367969, which are each incorporated by reference herein in their entirety.

In other instances, e.g., to facilitate sample multiplexing, a labelling agent that is specific to a particular cell feature may have a first plurality of the labelling agent (e.g., an antibody or lipophilic moiety) coupled to a first reporter oligonucleotide and a second plurality of the labelling agent coupled to a second reporter oligonucleotide.

In some aspects, these reporter oligonucleotides may comprise nucleic acid barcode sequences that permit identification of the labelling agent which the reporter oligonucleotide is coupled to. The selection of oligonucleotides as the reporter may provide advantages of being able to generate significant diversity in terms of sequence, while also being readily attachable to most biomolecules, e.g., antibodies, etc.

Attachment (coupling) of the reporter oligonucleotides to the labelling agents may be achieved through any of a variety of direct or indirect, covalent or non-covalent associations or attachments. For example, oligonucleotides may be covalently attached to a portion of a labelling agent (such a protein, e.g., an antibody or antibody fragment) using chemical conjugation techniques (e.g., Lightning-Link® antibody labelling kits available from Innova Biosciences), as well as other non-covalent attachment mechanisms, e.g., using biotinylated antibodies and oligonucleotides (or beads that include one or more biotinylated linker, coupled to oligonucleotides) with an avidin or streptavidin linker. Antibody and oligonucleotide biotinylation techniques are available. See, e.g., Fang, et al., “Fluoride-Cleavable Biotinylation Phosphoramidite for 5′-end-Labelling and Affinity Purification of Synthetic Oligonucleotides,” Nucleic Acids Res. Jan. 15, 2003; 31(2):708-715, which is entirely incorporated herein by reference for all purposes. Likewise, protein and peptide biotinylation techniques have been developed and are readily available. See, e.g., U.S. Pat. No. 6,265,552, which is entirely incorporated herein by reference for all purposes. Furthermore, click reaction chemistry such as a Methyltetrazine-PEG5-NHS Ester reaction, a TCO-PEG4-NHS Ester reaction, or the like, may be used to couple reporter oligonucleotides to labelling agents. Commercially available kits, such as those from Thunderlink and Abcam, and techniques common in the art may be used to couple reporter oligonucleotides to labelling agents as appropriate. In another example, a labelling agent is indirectly (e.g., via hybridization) coupled to a reporter oligonucleotide comprising a barcode sequence that identifies the label agent. For instance, the labelling agent may be directly coupled (e.g., covalently bound) to a hybridization oligonucleotide that comprises a sequence that hybridizes with a sequence of the reporter oligonucleotide. Hybridization of the hybridization oligonucleotide to the reporter oligonucleotide couples the labelling agent to the reporter oligonucleotide. In some embodiments, the reporter oligonucleotides are releasable from the labelling agent, such as upon application of a stimulus. For example, the reporter oligonucleotide may be attached to the labeling agent through a labile bond (e.g., chemically labile, photolabile, thermally labile, etc.) as generally described for releasing molecules from supports elsewhere herein. In some instances, the reporter oligonucleotides described herein may include one or more functional sequences that can be used in subsequent processing.

In some cases, the labelling agent can comprise a reporter oligonucleotide and a label. A label can be fluorophore, a radioisotope, a molecule capable of a colorimetric reaction, a magnetic particle, or any other suitable molecule or compound capable of detection. The label can be conjugated to a labelling agent (or reporter oligonucleotide) either directly or indirectly (e.g., the label can be conjugated to a molecule that can bind to the labelling agent or reporter oligonucleotide). In some cases, a label is conjugated to a first oligonucleotide that is complementary (e.g., hybridizes) to a sequence of the reporter oligonucleotide.

In some embodiments, an analyte binding moiety may include any molecule or moiety capable of binding to an analyte (e.g., a biological analyte, e.g., a macromolecular constituent). In some embodiments, disclosed herein is a method wherein the analyte binding moiety that binds to a biological analyte can include, but is not limited to, an antibody, or an epitope binding fragment thereof, a cell surface receptor binding molecule, a receptor ligand, a small molecule, a bi-specific antibody, a bi-specific T-cell engager, a T-cell receptor engager, a B-cell receptor engager, a pro-body, an aptamer, a monobody, an affimer, a darpin, and a protein scaffold, or any combination thereof. The analyte binding moiety can bind to the macromolecular constituent (e.g., analyte) with high affinity and/or with high specificity. The analyte binding moiety can include a nucleotide sequence (e.g., an oligonucleotide), which can correspond to at least a portion or an entirety of the analyte binding moiety. The analyte binding moiety can include a polypeptide and/or an aptamer (e.g., a polypeptide and/or an aptamer that binds to a specific target molecule, e.g., an analyte). The analyte binding moiety can include an antibody or antibody fragment (e.g., an antigen-binding fragment) that binds to a specific analyte (e.g., a polypeptide).

As used herein, the term “analyte binding moiety barcode” refers to a barcode that is associated with or otherwise identifies the analyte binding moiety. In some embodiments, by identifying an analyte binding moiety by identifying its associated analyte binding moiety barcode, the analyte to which the analyte binding moiety binds can also be identified. An analyte binding moiety barcode can be a nucleic acid sequence of a given length and/or sequence that is associated with the analyte binding moiety. An analyte binding moiety barcode can generally include any of the variety of aspects of barcodes described herein.

In some embodiments, an analyte binding moiety includes one or more antibodies or antigen binding fragments thereof. The antibodies or antigen binding fragments including the analyte binding moiety can specifically bind to a target analyte. In some embodiments, the analyte is a protein (e.g., a protein on a surface of the biological sample (e.g., a cell) or an intracellular protein). In some embodiments, a plurality of analyte labelling agents comprising a plurality of analyte binding moieties bind a plurality of analytes present in a biological sample. In some embodiments, the plurality of analytes includes a single species of analyte (e.g., a single species of polypeptide). In some embodiments in which the plurality of analytes includes a single species of analyte, the analyte binding moieties of the plurality of analyte labelling agents are the same. In some embodiments in which the plurality of analytes includes a single species of analyte, the analyte binding moieties of the plurality of analyte labelling agents are the different (e.g., members of the plurality of analyte labelling agents can have two or more species of analyte binding moieties, wherein each of the two or more species of analyte binding moieties binds a single species of analyte, e.g., at different binding sites). In some embodiments, the plurality of analytes includes multiple different species of analyte (e.g., multiple different species of polypeptides).

In some embodiments, multiple different species of analytes (e.g., polypeptides) from the biological sample can be subsequently associated with the one or more physical properties of the biological sample. For example, the multiple different species of analytes can be associated with locations of the analytes in the biological sample. Such information (e.g., proteomic information when the analyte binding moiety(ies) recognizes a polypeptide(s)) can be used in association with other spatial information (e.g., genetic information from the biological sample, such as DNA sequence information, transcriptome information (e.g., sequences of transcripts), or both). For example, a cell surface protein of a cell can be associated with one or more physical properties of the cell (e.g., a shape, size, activity, or a type of the cell). The one or more physical properties can be characterized by imaging the cell. The cell can be bound by an analyte labelling agent comprising an analyte binding moiety that binds to the cell surface protein and an analyte binding moiety barcode that identifies that analyte binding moiety, and the cell can be subjected to spatial analysis (e.g., any of the variety of spatial analysis methods described herein). Non-limiting aspects of spatial analysis methodologies are described in U.S. Pat. Pub. No. 10,308,982; U.S. Pat. Pub. No. 9,879,313; U.S. Pat. Pub. No. 9,868,979; Liu et al., bioRxiv 788992, 2020; U.S. Pat. Pub. No. 10,774,372; U.S. Pat. Pub. No. 10,774,374; WO 2018/091676; U.S. Pat. Pub. No. 10,030,261; U.S. Pat. Pub. No. 9,593,365; U.S. Pat. No. 10,002,316; U.S. Pat. No. 9,727,810; U.S. Pat. Pub. No. 10,640,816; Rodriques et al., Science 363(6434):1463-1467, 2019; Lee et al., Nat. Protoc. 10(3):442-458, 2015; U.S. Pat. Pub. No. 10,179,932; U.S. Pat. Pub. No. 10,138,509; Trejo et al., PLoS ONE 14(2):e0212031, 2019; U.S. Pat. Application Publication Nos. 2018/0245142; 2019/0177718; Chen et al., Science 348(6233):aaa6090, 2015; Gao et al., BMC Biol. 15:50, 2017; WO 2018/107054; U.S. Pat. Application Publication Nos. 2019/0161796; 2020/0224244; 2019/0194709; WO 2011/094669; U.S. Pat. No. 7,709,198; U.S. Pat. No. 8,604,182; U.S. Pat. No. 8,951,726; U.S. Pat. No. 9,783,841; U.S. Pat. No. 10,041,949; WO 2016/057552; U.S. Pat. Publication No 2021/0238665; U.S. Pat. Pub. Nos. 10,370,698; 10,724,078; 10,364,457; U.S. Pat. Pub. No. 10,317,321; U.S. Pat. Publication No 2021/0395796; U.S. Pat. Application Publication Nos. 2017/0241911; 2017/0029875; U.S. Pat. No. 10,059,990; U.S. Pat. Publication No 2020/0080136; and Gupta et al., Nature Biotechnol. 36:1197-1202, 2018, all of which are herein incorporated by reference in their entireties and can be used herein in any combination. Further non-limiting aspects of spatial analysis methodologies are described herein.

### (III) Signal Amplification And/or Detection

In some aspects, a biological sample affixed to a substrate fitted with an adapter as described herein may be subjected to in situ analysis, including in situ sequencing and/or in situ hybridization-based analysis of an intact tissue or non-homogenized tissue.

### A. In Situ Signal Amplification

In some aspects, the provided methods involve analyzing, e.g., detecting or determining, one or more sequences (e.g., any of the barcodes described herein) and/or in a product or derivative thereof. In some embodiments, a method disclosed herein may also comprise performing in situ signal amplification on a biological sample using the adapter described herein. In some embodiments, the present disclosure relates to the detection of nucleic acids sequences in situ using probe hybridization and generation of amplified signals associated with the probes, wherein background signal is reduced and sensitivity is increased.

Exemplary signal amplification methods include targeted deposition of detectable reactive molecules around the site of probe hybridization, targeted assembly of branched structures (e.g., bDNA or branched assay using locked nucleic acid (LNA)), programmed in situ growth of concatemers by enzymatic rolling circle amplification (RCA) (e.g., as described in US 2019/0055594, the content of which is incorporated herein by reference in its entirety), hybridization chain reaction, assembly of topologically catenated DNA structures using serial rounds of chemical ligation (clampFISH), signal amplification via hairpin-mediated concatemerization (e.g., as described in US 2020/0362398, the content of which is incorporated herein by reference in its entirety), e.g., primer exchange reactions such as signal amplification by exchange reaction (SABER) or SABER with DNA-Exchange (Exchange-SABER), or any combination thereof. In some embodiments, non-enzymatic signal amplification may be used.

The detectable reactive molecules may comprise tyramide, such as used in tyramide signal amplification (TSA) or multiplexed catalyzed reporter deposition (CARD)-FISH. In some embodiments, the detectable reactive molecule may be releasable and/or cleavable from a detectable label such as a fluorophore. In some embodiments, a method disclosed herein comprises multiplexed analysis of a biological sample comprising consecutive cycles of probe hybridization, fluorescence imaging, and signal removal, where the signal removal comprises removing the fluorophore from a fluorophore-labeled reactive molecule (e.g., tyramide). Exemplary detectable reactive reagents and methods are described in US 6,828,109, US 2019/0376956, US 2019/0376956, US 2022/0026433, US 2022/0128565, and US 2021/0222234, all of which are incorporated herein by reference in their entireties.

In some embodiments, hybridization chain reaction (HCR) can be used for signal amplification. HCR is an enzyme-free nucleic acid amplification based on a triggered chain of hybridization of nucleic acid molecules starting from HCR monomers, which hybridize to one another to form a nicked nucleic acid polymer. This polymer is the product of the HCR reaction which is ultimately detected in order to indicate the presence of the target analyte. HCR is described in detail in Dirks and Pierce, 2004, PNAS, 101(43), 15275-15278 and in US 7,632,641 and US 7,721,721 (see also US 2006/00234261; Chemeris et al, 2008 Doklady Biochemistry and Biophysics, 419, 53-55; Niu et al, 2010, 46, 3089-3091; Choi et al, 2010, Nat. Biotechnol. 28(11), 1208-1212; and Song et al, 2012, Analyst, 137, 1396-1401), all of which are herein incorporated by reference in their entireties. HCR monomers typically comprise a hairpin, or other metastable nucleic acid structure. In the simplest form of HCR, two different types of stable hairpin monomer, referred to here as first and second HCR monomers, undergo a chain reaction of hybridization events to form a long nicked double-stranded DNA molecule when an “initiator” nucleic acid molecule is introduced. The HCR monomers have a hairpin structure comprising a double stranded stem region, a loop region connecting the two strands of the stem region, and a single stranded region at one end of the double stranded stem region. The single stranded region which is exposed (and which is thus available for hybridization to another molecule, e.g. initiator or other HCR monomer) when the monomers are in the hairpin structure may be known as the “toehold region” (or “input domain”). The first HCR monomers each further comprise a sequence which is complementary to a sequence in the exposed toehold region of the second HCR monomers. This sequence of complementarity in the first HCR monomers may be known as the “interacting region” (or “output domain”). Similarly, the second HCR monomers each comprise an interacting region (output domain), e.g. a sequence which is complementary to the exposed toehold region (input domain) of the first HCR monomers. In the absence of the HCR initiator, these interacting regions are protected by the secondary structure (e.g. they are not exposed), and thus the hairpin monomers are stable or kinetically trapped (also referred to as “metastable”), and remain as monomers (e.g. preventing the system from rapidly equilibrating), because the first and second sets of HCR monomers cannot hybridize to each other. However, once the initiator is introduced, it is able to hybridize to the exposed toehold region of a first HCR monomer, and invade it, causing it to open up. This exposes the interacting region of the first HCR monomer (e.g. the sequence of complementarity to the toehold region of the second HCR monomers), allowing it to hybridize to and invade a second HCR monomer at the toehold region. This hybridization and invasion in turn opens up the second HCR monomer, exposing its interacting region (which is complementary to the toehold region of the first HCR monomers), and allowing it to hybridize to and invade another first HCR monomer. The reaction continues in this manner until all of the HCR monomers are exhausted (e.g. all of the HCR monomers are incorporated into a polymeric chain). Ultimately, this chain reaction leads to the formation of a nicked chain of alternating units of the first and second monomer species. The presence of the HCR initiator is thus required in order to trigger the HCR reaction by hybridization to and invasion of a first HCR monomer. The first and second HCR monomers are designed to hybridize to one another are thus may be defined as cognate to one another. They are also cognate to a given HCR initiator sequence. HCR monomers which interact with one another (hybridize) may be described as a set of HCR monomers or an HCR monomer, or hairpin, system.

An HCR reaction could be carried out with more than two species or types of HCR monomers. For example, a system involving three HCR monomers could be used. In such a system, each first HCR monomer may comprise an interacting region which binds to the toehold region of a second HCR monomer; each second HCR may comprise an interacting region which binds to the toehold region of a third HCR monomer; and each third HCR monomer may comprise an interacting region which binds to the toehold region of a first HCR monomer. The HCR polymerization reaction would then proceed as described above, except that the resulting product would be a polymer having a repeating unit of first, second and third monomers consecutively. Corresponding systems with larger numbers of sets of HCR monomers could readily be conceived.

In some embodiments, similar to HCR reactions that use hairpin monomers, linear oligo hybridization chain reaction (LO-HCR) can also be used for signal amplification. In some embodiments, provided herein is a method of detecting an analyte in a sample comprising: (i) performing a linear oligo hybridization chain reaction (LO-HCR), wherein an initiator is contacted with a plurality of LO-HCR monomers of at least a first and a second species to generate a polymeric LO-HCR product hybridized to a target nucleic acid molecule, wherein the first species comprises a first hybridization region complementary to the initiator and a second hybridization region complementary to the second species, wherein the first species and the second species are linear, single-stranded nucleic acid molecules; wherein the initiator is provided in one or more parts, and hybridizes directly or indirectly to or is comprised in the target nucleic acid molecule; and (ii) detecting the polymeric product, thereby detecting the analyte. In some embodiments, the first species and/or the second species may not comprise a hairpin structure. In some embodiments, the plurality of LO-HCR monomers may not comprise a metastable secondary structure. In some embodiments, the LO-HCR polymer may not comprise a branched structure. In some embodiments, performing the linear oligo hybridization chain reaction comprises contacting the target nucleic acid molecule with the initiator to provide the initiator hybridized to the target nucleic acid molecule. In any of the embodiments herein, the target nucleic acid molecule and/or the analyte can be an RCA product.

In some embodiments, detection of nucleic acids sequences in situ includes an assembly for branched signal amplification. In some embodiments, the assembly complex comprises an amplifier hybridized directly or indirectly (via one or more oligonucleotides) to a sequence (e.g., any of the barcodes described herein) present in a probe described herein and/or in a product or derivative thereof. In some embodiments, the assembly includes one or more amplifiers each including an amplifier repeating sequence. In some aspects, the one or more amplifiers is labeled. Described herein is a method of using the aforementioned assembly, including for example, using the assembly in multiplexed error-robust fluorescent in situ hybridization (MERFISH) applications, with branched DNA amplification for signal readout. In some embodiments, the amplifier repeating sequence is about 5-30 nucleotides, and is repeated N times in the amplifier. In some embodiments, the amplifier repeating sequence is about 20 nucleotides, and is repeated at least two times in the amplifier. In some aspects, the one or more amplifier repeating sequence is labeled. For exemplary branched signal amplification, see e.g., U.S. Pat. Pub. No. US 2020/0399689 and US 2022/0064697 and Xia et al., Multiplexed Detection of RNA using MERFISH and branched DNA amplification. Scientific Reports (2019), each of which is fully incorporated by reference herein.

In some embodiments, the sequences (e.g., any of the barcodes described herein) present in a probe described herein and/or in a product or derivative thereof can be detected in with a method that comprises signal amplification by performing a primer exchange reaction (PER). In various embodiments, a primer with domain on its 3′ end binds to a catalytic hairpin, and is extended with a new domain by a strand displacing polymerase. For example, a primer with domain 1 on its 3′ ends binds to a catalytic hairpin, and is extended with a new domain 1 by a strand displacing polymerase, with repeated cycles generating a concatemer of repeated domain 1 sequences. In various embodiments, the strand displacing polymerase is Bst. In various embodiments, the catalytic hairpin includes a stopper which releases the strand displacing polymerase. In various embodiments, branch migration displaces the extended primer, which can then dissociate. In various embodiments, the primer undergoes repeated cycles to form a concatemer primer. In various embodiments, the sample may be contacted with a plurality of concatemer primers and a plurality of labeled probes. See e.g., U.S. Pat. Pub. No. US20190106733, which is incorporated herein by reference in its entirety, for exemplary molecules and PER reaction components.

In some embodiments, the sequences detected are present in a probe described herein and/or in an amplification product of one or more polynucleotides, for instance, a circular probe or circularizable probe or probe set. In some embodiments, the amplifying is achieved by performing rolling circle amplification (RCA). In other embodiments, a primer that hybridizes to the circular probe or circularized probe is added and used as such for amplification. In some embodiments, the RCA comprises a linear RCA, a branched RCA, a dendritic RCA, or any combination thereof.

In some embodiments, the amplification is performed at a temperature between or between about 20° C. and about 60° C. In some embodiments, the amplification is performed at a temperature between or between about 30° C. and about 40° C. In some aspects, the amplification step, such as the rolling circle amplification (RCA) is performed at a temperature between at or about 25° C. and at or about 50° C., such as at or about 25° C., 27° C., 29° C., 31° C., 33° C., 35° C., 37° C., 39° C., 41° C., 43° C., 45° C., 47° C., or 49° C.

In some embodiments, upon addition of a DNA polymerase in the presence of appropriate dNTP precursors and other cofactors, a primer is elongated to produce multiple copies of the circular template. This amplification step can utilize isothermal amplification or non-isothermal amplification. In some embodiments, after the formation of the hybridization complex and association of the amplification probe, the hybridization complex is rolling-circle amplified to generate an amplicon (e.g., a DNA nanoball) containing multiple copies of the circular template or a sequence thereof. Multiple techniques for rolling circle amplification (RCA) can be utilized, such as linear RCA, a branched RCA, a dendritic RCA, or any combination thereof. (See, e.g., Baner et al, Nucleic Acids Research, 26:5073-5078, 1998; Lizardi et al, Nature Genetics 19:226, 1998; Mohsen et al., Acc Chem Res. 2016 November 15; 49(11): 2540-2550; Schweitzer et al. Proc. Natl Acad. Sci. USA 97:10113-9, 2000; Faruqi et al, BMC Genomics 2:4, 2000; Nallur et al, Nucl. Acids Res. 29:E118, 2001; Dean et al. Genome Res. 11:1095-1099, 2001; Schweitzer et al, Nature Biotech. 20:359-365, 2002; U.S. Pat. Nos. 6,054,274, 6,291,187, 6,323,009, 6,344,329 and 6,368,801, all of which are herein incorporated by reference in their entireties). Exemplary polymerases for use in RCA comprise DNA polymerase such phi29 (φ29) polymerase, Klenow fragment, Bacillus stearothermophilus DNA polymerase (BST), T4 DNA polymerase, T7 DNA polymerase, or DNA polymerase I. In some aspects, DNA polymerases that have been engineered or mutated to have desirable characteristics can be employed. In some embodiments, the polymerase is phi29 DNA polymerase.

In some aspects, during the amplification step, modified nucleotides can be added to the reaction to incorporate the modified nucleotides in the amplification product (e.g., nanoball). Exemplary of the modified nucleotides comprise amine-modified nucleotides. In some aspects of the methods, for example, for anchoring or cross-linking of the generated amplification product (e.g., nanoball) to a scaffold, to cellular structures and/or to other amplification products (e.g., other nanoballs). In some aspects, the amplification products comprises a modified nucleotide, such as an amine-modified nucleotide. In some embodiments, the amine-modified nucleotide comprises an acrylic acid N- hydroxysuccinimide moiety modification. Examples of other amine-modified nucleotides comprise, but are not limited to, a 5-Aminoallyl-dUTP moiety modification, a 5-Propargylamino-dCTP moiety modification, a N6-6-Aminohexyl-dATP moiety modification, or a 7-Deaza-7-Propargylamino-dATP moiety modification.

In some aspects, the polynucleotides and/or amplification product (e.g., amplicon) can be anchored to a polymer matrix. For example, the polymer matrix can be a hydrogel. In some embodiments, one or more of the polynucleotide probe(s) can be modified to contain functional groups that can be used as an anchoring site to attach the polynucleotide probes and/or amplification product to a polymer matrix. Exemplary modification and polymer matrix that can be employed in accordance with the provided embodiments comprise those described in, for example, US 10,138,509, US 10,266,888, US 10,494,662, and US 10,545,075, all of which are incorporated herein by reference in their entireties. In some examples, the scaffold also contains modifications or functional groups that can react with or incorporate the modifications or functional groups of the probe set or amplification product. In some examples, the scaffold can comprise oligonucleotides, polymers or chemical groups, to provide a matrix and/or support structures.

The amplification products may be immobilized within the matrix generally at the location of the nucleic acid being amplified, thereby creating a localized colony of amplicons. The amplification products may be immobilized within the matrix by steric factors. The amplification products may also be immobilized within the matrix by covalent or noncovalent bonding. In this manner, the amplification products may be considered to be attached to the matrix. By being immobilized to the matrix, such as by covalent bonding or cross-linking, the size and spatial relationship of the original amplicons is maintained. By being immobilized to the matrix, such as by covalent bonding or cross-linking, the amplification products are resistant to movement or unraveling under mechanical stress.

### B. Signal Detection

In some embodiments, provided herein are methods comprising in situ assays using microscopy as a readout, e.g., nucleic acid sequencing, hybridization, or other detection or determination methods involving an optical readout. In some cases, analysis is performed on one or more images captured, and may comprise processing the image(s) and/or quantifying signals observed. In some embodiments, images of signals from different fluorescent channels and/or detectable probe hybridization (and optionally ligation) cycles can be compared and analyzed. In some embodiments, images of signals from different fluorescent channels and/or detectable probe hybridization (and ligation) cycles can be compared and analyzed. In some embodiments, images of signals (or absence thereof) at a particular location in a sample from different fluorescent channels and/or sequential detectable probe hybridization (and optionally ligation) cycles can be aligned to analyze an analyte at the location. In some embodiments, images of signals (or absence thereof) at a particular location in a sample from different fluorescent channels and/or sequential detectable probe hybridization (and ligation) cycles can be aligned to analyze an analyte at the location. For instance, a particular location in a sample can be tracked and signal spots from sequential hybridization (and optionally ligation) cycles can be analyzed to detect a target polynucleotide sequence (e.g., a barcode sequence or subsequence thereof) in a nucleic acid at the location. For instance, a particular location in a sample can be tracked and signal spots from sequential hybridization (and ligation) cycles can be analyzed to detect a target polynucleotide sequence (e.g., a barcode sequence or subsequence thereof) in a nucleic acid at the location. The analysis may comprise processing information of one or more cell types, one or more types of analytes, a number or level of analyte, and/or a number or level of cells detected in a particular region of the sample. In some embodiments, the analysis comprises detecting a sequence e.g., a barcode sequence present in an amplification product at a location in the sample. In some embodiments, the analysis includes quantification of puncta (e.g., if amplification products are detected). In some cases, the analysis includes determining whether particular cells and/or signals are present that correlate with one or more analytes from a particular panel. In some embodiments, the obtained information may be compared to a positive and negative control, or to a threshold of a feature to determine if the sample exhibits a certain feature or phenotype. In some cases, the information may comprise signals from a cell, a region, and/or comprise readouts from multiple detectable labels. In some case, the analysis further includes displaying the information from the analysis or detection step. In some embodiments, software may be used to automate the processing, analysis, and/or display of data.

In some aspects, detection or determination of a sequence of one, two, three, four, five, or more nucleotides of a target nucleic acid is performed in situ in a cell in an intact tissue. In some embodiments, the assay comprises detecting the presence or absence of an amplification product (e.g., RCA product). In some embodiments, the present disclosure provides methods for high-throughput profiling of a large number of targets in situ, such as transcripts and/or DNA loci, e.g., for detecting and/or quantifying nucleic acids and/or proteins in cells, tissues, organs or organisms.

In some aspects, provided herein is a method comprising analyzing biological targets based on in situ hybridization of probes comprising nucleic acid sequences. In some embodiments, the method comprises sequential hybridization of detectably-labelled oligonucleotides to barcoded probes that directly or indirectly bind to biological targets in a sample. In some embodiments, a detectably-labelled oligonucleotide directly binds to one or more barcoded probes. In some embodiments, a detectably-labelled oligonucleotide indirectly binds to one or more barcoded probes, e.g., via one or more bridging nucleic acid molecules.

In some aspects, an in situ hybridization based assay is used to localize and analyze nucleic acid sequences (e.g., a DNA or RNA molecule comprising one or more specific sequences of interest) within a native biological sample, e.g., a portion or section of tissue or a single cell. In some embodiments, the in situ assay is used to analyze the presence, absence, an amount or level of mRNA transcripts (e.g., a transcriptome or a subset thereof, or mRNA molecules of interest) in a biological sample, while preserving spatial context. In some embodiments, the present disclosure provides compositions and methods for in situ hybridization using directly or indirectly labeled molecules, e.g., complementary DNA or RNA or modified nucleic acids, as probes that bind or hybridize to a target nucleic acids within a biological sample of interest.

Nucleic acid probes, in some examples, may be labelled with radioisotopes, epitopes, hapten, biotin, or fluorophores, to enable detection of the location of specific nucleic acid sequences on chromosomes or in tissues. In some embodiments, probes are locus specific (e.g., gene specific) and bind or couple to specific regions of a chromosome. In alternative embodiments, probes are alphoid or centromeric repeat probes that bind or couple to repetitive sequences within each chromosome. Probes may also be whole chromosome probes (e.g., multiple smaller probes) that bind or couple to sequences along an entire chromosome.

In some embodiments, provided herein is a method comprising DNA in situ hybridization to measure and localize DNA. In some embodiments, provided herein is a method RNA in situ hybridization to measure and localize RNAs (e.g., mRNAs, IncRNAs, and miRNAs) within a biological sample (e.g., a fixed tissue sample). In some embodiments, RNA in situ hybridization involves single-molecule RNA fluorescence in situ hybridization (FISH). In some embodiments, fluorescently labeled nucleic acid probes are hybridized to pre-determined RNA targets, to visualize gene expression in a biological sample. In some embodiments, a FISH method comprises using a single nucleic acid probe specific to each target, e.g., single-molecule FISH (smFISH). The use of smFISH may produce a fluorescence signal that allows for quantitative measurement of RNA transcripts. In some embodiments, smFISH comprises a set of nucleic acid probes, about 50 base pairs in length, wherein each probe is coupled to a set fluorophores. For example, the set of nucleic acid probes may comprise five probes, wherein each probe coupled to five fluorophores. In some embodiments, said nucleic acid probes are instead each coupled to one fluorophore. For example, a smFISH protocol may use a set of about 40 nucleic acid probes, about 20 base pairs in length, each coupled to a single fluorophore. In some embodiments, the length of the nucleic acid probes varies, comprising 10 to 100 base pairs, such as 30 to 60 base pairs. Alternatively, a plurality of nucleic acid probes targeting different regions of the same RNA transcript may be used. It will be appreciated by those skilled in the art that the type of nucleic acid probes, the number of nucleic acid probes, the number of fluorophores coupled to said probes, and the length of said probes, may be varied to fit the specifications of the individual assay.

In some aspects, the provided methods further involve analyzing, e.g., detecting or determining, one or more sequences present in the target nucleic acid and/or in the nucleic acid as described herein. In some embodiments, the detecting comprises hybridizing one or more detectably labeled probes to the nucleic acid concatemer, or via hybridization to adapter probes that hybridize to the nucleic acid concatemer). In some embodiments, the analysis comprises determining the sequence of all or a portion of the nucleic acid concatemer (e.g., a barcode sequence or a complement thereof), wherein the sequence is indicative of a sequence of the target nucleic acid.

Methods for binding and identifying a target nucleic acid that uses various probes or oligonucleotides have been described in, e.g., US2003/0013091, US2007/0166708, US2010/0015607, US2010/0261026, US2010/0262374, US2010/0112710, US2010/0047924, and US2014/0371088, each of which is incorporated herein by reference in its entirety. Detectably-labeled probes can be useful for detecting multiple target nucleic acids and be detected in one or more hybridization cycles (e.g., sequential hybridization in a FISH-type assay, sequencing by hybridization).

In some embodiments, the methods comprise sequencing all or a portion of the nucleic acid. In some embodiments, the sequence of the nucleic acid, or barcode thereof, is indicative of a sequence of the target nucleic acid to which the nucleic acid is hybridized. In some embodiments, the analysis and/or sequence determination comprises sequencing all or a portion of the nucleic acid and/or in situ hybridization to the nucleic acid. In some embodiments, the sequencing step involves sequencing by hybridization, sequencing by ligation, sequencing by synthesis, sequencing by binding, and/or fluorescent in situ sequencing (FISSEQ), hybridization-based in situ sequencing and/or wherein the in situ hybridization comprises sequential fluorescent in situ hybridization. In some embodiments, the analysis and/or sequence determination comprises detecting a polymer generated by a hybridization chain reaction (HCR) reaction, see e.g., US2017/0009278, which is incorporated herein by reference in its entirety, for exemplary probes and HCR reaction components. In some embodiments, the detection or determination comprises hybridizing to the first overhang a detection oligonucleotide labeled with a fluorophore, an isotope, a mass tag, or a combination thereof. In some embodiments, the detection or determination comprises imaging the probe hybridized to the target nucleic acid (e.g., imaging one or more detectably labeled probes hybridized thereto). In some embodiments, the target nucleic acid is an mRNA in a tissue sample, and the detection or determination is performed when the target nucleic acid and/or the amplification product is in situ in the tissue sample. In some embodiments, the target nucleic acid is an amplification product (e.g., a rolling circle amplification product/nucleic acid).

In some aspects, the provided methods comprise imaging the probe hybridized to the nucleic acid, for example, via binding of one or more detectable probes and detecting signals associated with detectable labels. In some embodiments, the detectable probe comprises a detectable label that can be measured and quantitated. The terms “label” and “detectable label” comprise a directly or indirectly detectable moiety that is associated with (e.g., conjugated to) a molecule to be detected, comprising, but not limited to, fluorophores, radioactive isotopes, fluorescers, chemiluminescers, enzymes, enzyme substrates, enzyme cofactors, enzyme inhibitors, chromophores, dyes, metal ions, metal sols, ligands (e.g., biotin or haptens) and the like.

The term “fluorophore” comprises a substance or a portion thereof that is capable of exhibiting fluorescence in the detectable range. Particular examples of labels that may be used in accordance with the provided embodiments comprise, but are not limited to phycoerythrin, Alexa dyes, fluorescein, YPet, CyPet, Cascade blue, allophycocyanin, Cy3, Cy5, Cy7, rhodamine, dansyl, umbelliferone, Texas red, luminol, acradimum esters, biotin, green fluorescent protein (GFP), enhanced green fluorescent protein (EGFP), yellow fluorescent protein (YFP), enhanced yellow fluorescent protein (EYFP), blue fluorescent protein (BFP), red fluorescent protein (RFP), firefly luciferase, Renilla luciferase, NADPH, beta-galactosidase, horseradish peroxidase, glucose oxidase, alkaline phosphatase, chloramphenical acetyl transferase, and urease.

Fluorescence detection in tissue samples can often be hindered by the presence of strong background fluorescence. “Autofluorescence” is the general term used to distinguish background fluorescence (that can arise from a variety of sources, including aldehyde fixation, extracellular matrix components, red blood cells, lipofuscin, and the like) from the desired immunofluorescence from the fluorescently labeled antibodies or probes. Tissue autofluorescence can lead to difficulties in distinguishing the signals due to fluorescent antibodies or probes from the general background. In some embodiments, a method disclosed herein utilizes one or more agents to reduce tissue autofluorescence, for example, Autofluorescence Eliminator (Sigma/EMD Millipore), TrueBlack Lipofuscin Autofluorescence Quencher (Biotium), MaxBlock Autofluorescence Reducing Reagent Kit (MaxVision Biosciences), and/or a very intense black dye (e.g., Sudan Black, or comparable dark chromophore).

In some embodiments, a detectable probe containing a detectable label can be used to detect one or more nucleic acid concatemer(s) crosslinked to the complementary strand of the target nucleic acid described herein. In some embodiments, the methods involve incubating the detectable probe containing the detectable label with the sample, washing unbound detectable probe, and detecting the label, e.g., by imaging. In some embodiments, the nucleic acid concatemer(s) remain crosslinked to the target nucleic acid during the washing and detecting steps.

Examples of detectable labels comprise but are not limited to various radioactive moieties, enzymes, prosthetic groups, fluorescent markers, luminescent markers, bioluminescent markers, metal particles, protein-protein binding pairs and protein-antibody binding pairs. Examples of fluorescent proteins comprise, but are not limited to, yellow fluorescent protein (YFP), green fluorescence protein (GFP), cyan fluorescence protein (CFP), umbelliferone, fluorescein, fluorescein isothiocyanate, rhodamine, dichlorotriazinylamine fluorescein, dansyl chloride and phycoerythrin.

Examples of bioluminescent markers comprise, but are not limited to, luciferase (e.g., bacterial, firefly and click beetle), luciferin, aequorin and the like. Examples of enzyme systems having visually detectable signals comprise, but are not limited to, galactosidases, glucorimidases, phosphatases, peroxidases and cholinesterases. Identifiable markers also comprise radioactive compounds such as ¹²⁵I, ³⁵S, ¹⁴C, or ³H. Identifiable markers are commercially available from a variety of sources.

Examples of fluorescent labels and nucleotides and/or polynucleotides conjugated to such fluorescent labels comprise those described in, for example, Hoagland, Handbook of Fluorescent Probes and Research Chemicals, Ninth Edition (Molecular Probes, Inc., Eugene, 2002); Keller and Manak, DNA Probes, 2nd Edition (Stockton Press, New York, 1993); Eckstein, editor, Oligonucleotides and Analogues: A Practical Approach (IRL Press, Oxford, 1991); and Wetmur, Critical Reviews in Biochemistry and Molecular Biology, 26:227- 259 (1991), all of which are herein incorporated by reference in their entireties. In some embodiments, exemplary techniques and methods methodologies applicable to the provided embodiments comprise those described in, for example, US 4,757,141, US 5,151,507 and US 5,091,519, all of which are herein incorporated by reference in their entireties. In some embodiments, one or more fluorescent dyes are used as labels for labeled target sequences, for example, as described in US 5,188,934 (4,7-dichlorofluorescein dyes); US 5,366,860 (spectrally resolvable rhodamine dyes); US 5,847,162 (4,7- dichlororhodamine dyes); US 4,318,846 (ether-substituted fluorescein dyes); US 5,800,996 (energy transfer dyes); US 5,066,580 (xanthine dyes); and US 5,688,648 (energy transfer dyes), all of which are herein incorporated by reference in their entireties. Labelling can also be carried out with quantum dots, as described in US 6,322,901, US 6,576,291, US 6,423,551, US 6,251,303, US 6,319,426, US 6,426,513, US 6,444,143, US 5,990,479, US 6,207,392, US 2002/0045045 and US 2003/0017264, all of which are herein incorporated by reference in their entireties. In some embodiments, the term “fluorescent label” comprises a signaling moiety that conveys information through the fluorescent absorption and/or emission properties of one or more molecules. Exemplary fluorescent properties comprise fluorescence intensity, fluorescence lifetime, emission spectrum characteristics and energy transfer.

Examples of commercially available fluorescent nucleotide analogues readily incorporated into nucleotide and/or polynucleotide sequences comprise, but are not limited to, Cy3-dCTP, Cy3-dUTP, Cy5-dCTP, Cy5-dUTP (Amersham Biosciences, Piscataway, N.J.), fluorescein- !2-dUTP, tetramethylrhodamine-6-dUTP, TEXAS RED™-5-dUTP, CASCADE BLUE™-7-dUTP, BODIPY TMFL-14-dUTP, BODIPY TMR-14-dUTP, BODIPY TMTR-14-dUTP, RHOD AMINE GREEN™-5-dUTP, OREGON GREENR™ 488-5-dUTP, TEXAS RED™-12-dUTP, BODIPY™ 630/650-14-dUTP, BODIPY™ 650/665-14-dUTP, ALEXA FLUOR™ 488-5-dUTP, ALEXA FLUOR™ 532-5-dUTP, ALEXA FLUOR™ 568-5-dUTP, ALEXA FLUOR™ 594-5-dUTP, ALEXA FLUOR™ 546-14-dUTP, fluorescein- 12-UTP, tetramethylrhodamine-6-UTP, TEXAS RED™-5- UTP, mCherry, CASCADE BLUE™-7-UTP, BODIPY™ FL-14-UTP, BODIPY TMR- 14-UTP, BODIPY™ TR-14-UTP, RHOD AMINE GREEN™-5-UTP, ALEXA FLUOR™ 488-5-UTP, and ALEXA FLUOR™ 546-14-UTP (Molecular Probes, Inc. Eugene, Oreg.). Methods are known for custom synthesis of nucleotides having other fluorophores (See, Henegariu et al. (2000) Nature Biotechnol. 18:345) , the content of which is herein incorporated by reference in its entirety.

Other fluorophores available for post-synthetic attachment comprise, but are not limited to, ALEXA FLUOR™ 350, ALEXA FLUOR™ 532, ALEXA FLUOR™ 546, ALEXA FLUOR™ 568, ALEXA FLUOR™ 594, ALEXA FLUOR™ 647, BODIPY 493/503, BODIPY FL, BODIPY R6G, BODIPY 530/550, BODIPY TMR, BODIPY 558/568, BODIPY 558/568, BODIPY 564/570, BODIPY 576/589, BODIPY 581/591, BODIPY 630/650, BODIPY 650/665, Cascade Blue, Cascade Yellow, Dansyl, lissamine rhodamine B, Marina Blue, Oregon Green 488, Oregon Green 514, Pacific Blue, rhodamine 6G, rhodamine green, rhodamine red, tetramethyl rhodamine, Texas Red (available from Molecular Probes, Inc., Eugene, Oreg.), Cy2, Cy3.5, Cy5.5, and Cy7 (Amersham Biosciences, Piscataway, N.J.). FRET tandem fluorophores may also be used, comprising, but not limited to, PerCP-Cy5.5, PE-Cy5, PE-Cy5.5, PE-Cy7, PE-Texas Red, APC-Cy7, PE-Alexa dyes (610, 647, 680), and APC-Alexa dyes.

In some cases, metallic silver or gold particles may be used to enhance signal from fluorescently labeled nucleotide and/or polynucleotide sequences (Lakowicz et al. (2003) Bio Techniques 34:62, which is incorporated herein by reference in its entirety).

Biotin, or a derivative thereof, may also be used as a label on a nucleotide and/or a polynucleotide sequence, and subsequently bound by a detectably labeled avidin/streptavidin derivative (e.g., phycoerythrin-conjugated streptavidin), or a detectably labeled anti-biotin antibody. Digoxigenin may be incorporated as a label and subsequently bound by a detectably labeled anti-digoxigenin antibody (e.g., fluoresceinated anti-digoxigenin). An aminoallyl-dUTP residue may be incorporated into a polynucleotide sequence and subsequently coupled to an N-hydroxy succinimide (NHS) derivatized fluorescent dye. In general, any member of a conjugate pair may be incorporated into a detection polynucleotide provided that a detectably labeled conjugate partner can be bound to permit detection. In some embodiments, the term antibody refers to an antibody molecule of any class, or any sub-fragment thereof, such as an Fab.

Other suitable labels for a polynucleotide sequence may comprise fluorescein (FAM), digoxigenin, dinitrophenol (DNP), dansyl, biotin, bromodeoxyuridine (BrdU), hexahistidine (6xHis), and phosphor-amino acids (e.g., P-tyr, P-ser, P-thr). In some embodiments the following hapten/antibody pairs are used for detection, in which each of the antibodies is derivatized with a detectable label: biotin/a-biotin, digoxigenin/a- digoxigenin, dinitrophenol (DNP)/a-DNP, 5-Carboxyfluorescein (FAM)/a-FAM.

In some embodiments, a nucleotide and/or a oligonucleotide sequence can be indirectly labeled, especially with a hapten that is then bound by a capture agent, e.g., as disclosed in US 5,344,757, US 5,702,888, US 5,354,657, US 5,198,537 and US 4,849,336, and PCT Publication WO 91/17160, all of which are herein incorporated by reference in their entireties. Many different hapten-capture agent pairs are available for use. Exemplary haptens comprise, but are not limited to, biotin, des-biotin and other derivatives, dinitrophenol, dansyl, fluorescein, Cy5, and digoxigenin. For biotin, a capture agent may be avidin, streptavidin, or antibodies. Antibodies may be used as capture agents for the other haptens (many dye-antibody pairs being commercially available, e.g., Molecular Probes, Eugene, Oreg.).

In some aspects, the detecting involves using detection methods such as flow cytometry; sequencing; probe binding and electrochemical detection; pH alteration; catalysis induced by enzymes bound to DNA tags; quantum entanglement; Raman spectroscopy; terahertz wave technology; and/or scanning electron microscopy. In some aspects, the flow cytometry is mass cytometry or fluorescence-activated flow cytometry. In some aspects, the detecting comprises performing microscopy, scanning mass spectrometry or other imaging techniques described herein. In such aspects, the detecting comprises determining a signal, e.g., a fluorescent signal.

In some aspects, the detection (comprising imaging) is carried out using any of a number of different types of microscopy, e.g., confocal microscopy, two-photon microscopy, light-field microscopy, intact tissue expansion microscopy, and/or CLARITY™-optimized light sheet microscopy (COLM).

In some embodiments, fluorescence microscopy is used for detection and imaging of the detectable probe. In some aspects, a fluorescence microscope is an optical microscope that uses fluorescence and phosphorescence instead of, or in addition to, reflection and absorption to study properties of organic or inorganic substances. In fluorescence microscopy, a sample is illuminated with light of a wavelength which excites fluorescence in the sample. The fluoresced light, which is usually at a longer wavelength than the illumination, is then imaged through a microscope objective. Two filters may be used in this technique; an illumination (or excitation) filter which ensures the illumination is near monochromatic and at the correct wavelength, and a second emission (or barrier) filter which ensures none of the excitation light source reaches the detector. Alternatively, these functions may both be accomplished by a single dichroic filter. The “fluorescence microscope” comprises any microscope that uses fluorescence to generate an image, whether it is a more simple set up like an epifluorescence microscope, or a more complicated design such as a confocal microscope, which uses optical sectioning to get better resolution of the fluorescent image.

In some embodiments, confocal microscopy is used for detection and imaging of the detectable probe. Confocal microscopy uses point illumination and a pinhole in an optically conjugate plane in front of the detector to eliminate out-of-focus signal. As only light produced by fluorescence very close to the focal plane can be detected, the image’s optical resolution, particularly in the sample depth direction, is much better than that of wide-field microscopes. However, as much of the light from sample fluorescence is blocked at the pinhole, this increased resolution is at the cost of decreased signal intensity, so long exposures are often required. As only one point in the sample is illuminated at a time, 2D or 3D imaging requires scanning over a regular raster (e.g., a rectangular pattern of parallel scanning lines) in the specimen. The achievable thickness of the focal plane is defined mostly by the wavelength of the used light divided by the numerical aperture of the objective lens, but also by the optical properties of the specimen. The thin optical sectioning possible makes these types of microscopes particularly good at 3D imaging and surface profiling of samples. CLARITY™-optimized light sheet microscopy (COLM) provides an alternative microscopy for fast 3D imaging of large clarified samples. COLM interrogates large immunostained tissues, permits increased speed of acquisition and results in a higher quality of generated data.

Other types of microscopy that can be employed comprise bright field microscopy, oblique illumination microscopy, dark field microscopy, phase contrast, differential interference contrast (DIC) microscopy, interference reflection microscopy (also known as reflected interference contrast, or RIC), single plane illumination microscopy (SPIM), super-resolution microscopy, laser microscopy, electron microscopy (EM), Transmission electron microscopy (TEM), Scanning electron microscopy (SEM), reflection electron microscopy (REM), Scanning transmission electron microscopy (STEM) and low- voltage electron microscopy (LVEM), scanning probe microscopy (SPM), atomic force microscopy (ATM), ballistic electron emission microscopy (BEEM), chemical force microscopy (CFM), conductive atomic force microscopy (C- AFM), electrochemical scanning tunneling microscope (ECSTM), electrostatic force microscopy (EFM), fluidic force microscope (FluidFM), force modulation microscopy (FMM), feature-oriented scanning probe microscopy (FOSPM), kelvin probe force microscopy (KPFM), magnetic force microscopy (MFM), magnetic resonance force microscopy (MRFM), near-field scanning optical microscopy (NSOM) (or SNOM, scanning near-field optical microscopy, SNOM, Piezoresponse Force Microscopy (PFM), PSTM, photon scanning tunneling microscopy (PSTM), PTMS, photothermal microspectroscopy/ microscopy (PTMS), SCM, scanning capacitance microscopy (SCM), SECM, scanning electrochemical microscopy (SECM), SGM, scanning gate microscopy (SGM), SHPM, scanning Hall probe microscopy (SHPM), SICM, scanning ion-conductance microscopy (SICM), SPSM spin polarized scanning tunneling microscopy (SPSM), SSRM, scanning spreading resistance microscopy (SSRM), SThM, scanning thermal microscopy (SThM), STM, scanning tunneling microscopy (STM), STP, scanning tunneling potentiometry (STP), SVM, scanning voltage microscopy (SVM), and synchrotron x-ray scanning tunneling microscopy (SXSTM), and intact tissue expansion microscopy (exM).

In some embodiments, sequencing can be performed in situ and such sequencing methods typically involve incorporation of a labeled nucleotide (e.g., fluorescently labeled mononucleotides or dinucleotides) in a sequential, template-dependent manner or hybridization of a labeled primer (e.g., a labeled random hexamer) to a nucleic acid template such that the identities (e.g., nucleotide sequence) of the incorporated nucleotides or labeled primer extension products can be determined, and consequently, the nucleotide sequence of the corresponding template nucleic acid. Aspects of in situ sequencing are described, for example, in Mitra et al., (2003) Anal. Biochem. 320, 55-65, and Lee et al., (2014) Science, 343(6177), 1360-1363, each of which are herein incorporated by reference in their entireties. In addition, examples of methods and systems for performing in situ sequencing are described in US 2016/0024555, US 2019/0194709, and in US 10,138,509, US 10,494,662 and US 10,179,932, all of which are herein incorporated by reference in their entireties. Exemplary techniques for in situ sequencing comprise, but are not limited to, STARmap (described for example in Wang et al., (2018) Science, 361(6499) 5691), MERFISH (described for example in Moffitt, (2016) Methods in Enzymology, 572, 1-49), hybridization-based in situ sequencing (HybISS) (described for example in Gyllborg et al., Nucleic Acids Res (2020) 48(19):e112), and FISSEQ (described for example in US 2019/0032121) , all of which are herein incorporated by reference in their entireties.

In some embodiments, sequencing can be performed by sequencing-by-synthesis (SBS). In some embodiments, a sequencing primer is complementary to sequences at or near the one or more barcode(s). In such embodiments, sequencing-by-synthesis can comprise reverse transcription and/or amplification in order to generate a template sequence from which a primer sequence can bind. Exemplary SBS methods comprise those described for example, but not limited to, US 2007/0166705, US 2006/0188901, US 7,057,026, US 2006/0240439, US 2006/0281109, US 2011/0059865, US 2005/0100900, US 9,217,178, US 2009/0118128, US 2012/0270305, US 2013/0260372, and US 2013/0079232, all of which are herein incorporated by reference in their entireties.

In some embodiments, sequencing can be performed by sequential fluorescence hybridization (e.g., sequencing by hybridization). Sequential fluorescence hybridization can involve sequential hybridization of detectable probes comprising an oligonucleotide and a detectable label.

In some embodiments, sequencing can be performed using single molecule sequencing by ligation. Such techniques utilize DNA ligase to incorporate oligonucleotides and identify the incorporation of such oligonucleotides. The oligonucleotides typically have different labels that are correlated with the identity of a particular nucleotide in a sequence to which the oligonucleotides hybridize. Aspects and features involved in sequencing by ligation are described, for example, in Shendure et al. Science (2005), 309: 1728-1732, and in US 5,599,675; US 5,750,341; US 6,969,488; US 6,172,218; US and 6,306,59, all of which are herein incorporated by reference in their entireties 7.

In some embodiments, the barcodes of a probe or product thereof can be targeted by one or more other probes, such as unlabeled intermediate probes (which may be targeted by detectably labeled probes) or detectably labeled probes (e.g., fluorescently labeled oligonucleotides). In some embodiments, one or more decoding schemes are used to decode the signals, such as fluorescence, for sequence determination. In any of the embodiments herein, barcodes can be analyzed (e.g., detected or sequenced) using any suitable methods or techniques, comprising those described herein, such as RNA sequential probing of targets (RNA SPOTs), sequential fluorescent in situ hybridization (seqFISH), single-molecule fluorescent in situ hybridization (smFISH), multiplexed error-robust fluorescence in situ hybridization (MERFISH), hybridization-based in situ sequencing (HybISS), in situ sequencing, targeted in situ sequencing, fluorescent in situ sequencing (FISSEQ), or spatially-resolved transcript amplicon readout mapping (STARmap). In some embodiments, the methods provided herein comprise analyzing the barcodes by sequential hybridization and detection with a plurality of labelled probes (e.g., detection oligonucleotides). Exemplary decoding schemes are described in Eng et al., “Transcriptome-scale Super-Resolved Imaging in Tissues by RNA SeqFISH+,” Nature 568(7751):235-239 (2019); Chen et al., “Spatially resolved, highly multiplexed RNA profiling in single cells,” Science; 348(6233):aaa6090 (2015); Gyllborg et al., Nucleic Acids Res (2020) 48(19):e112; US 10,457,980 B2; US 2016/0369329 A1; WO 2018/026873 A1; and US 2017/0220733 A1, all of which are incorporated by reference in their entirety. In some embodiments, these assays enable signal amplification, combinatorial decoding, and error correction schemes at the same time.

In some embodiments, nucleic acid hybridization can be used for sequencing. These methods utilize labeled nucleic acid decoder probes that are complementary to at least a portion of a barcode sequence. Multiplex decoding can be performed with pools of many different probes with distinguishable labels. Non-limiting examples of nucleic acid hybridization sequencing are described for example in US 8,460,865, and in Gunderson et al., Genome Research 14:870-877 (2004), both of which are herein incorporated by reference in their entireties.

In some embodiments, real-time monitoring of DNA polymerase activity can be used during sequencing. For example, nucleotide incorporations can be detected through fluorescence resonance energy transfer (FRET), as described for example in Levene et al., Science (2003), 299, 682-686, Lundquist et al., Opt. Lett. (2008), 33, 1026-1028, and Korlach et al., Proc. Natl. Acad. Sci. USA (2008), 105, 1176-1181, all of which are herein incorporated by reference in their entireties.

In some aspects, the analysis and/or sequence determination can be carried out at room temperature for best preservation of tissue morphology with low background noise and error reduction. In some embodiments, the analysis and/or sequence determination comprises eliminating error accumulation as sequencing proceeds.

In some embodiments, the analysis and/or sequence determination involves washing to remove unbound polynucleotides, thereafter revealing a fluorescent product for imaging.

### V. Kits

Also provided herein are kits for performing the methods of processing a biological sample as described in the present disclosure.

### A. Sample Adapter Kit

In another aspect, provided herein is a kit for use in adapting a biological sample affixed to a substrate for in situ analysis according to the methods provided herein. For example, provided herein is a kit containing an adapter for adapting a biological sample immobilized to a non-specialized (e.g., unmodified or partially modified) substrate for in situ analysis, wherein the adapter comprises a top surface and a bottom surface, and a through hole, wherein the through hole can form a space surrounding the biological sample or a region of interest thereof, wherein the bottom surface can form a substantially impervious seal with the substrate; and an area of the adapter surrounding the biological sample or the region of interest is hydrophobic.

In some embodiments, the adapter comprises one or more positioning markers and/or fiducial markers on the top surface, on the bottom surface, and/or within the adapter. In one aspect, provided herein is a kit comprising an adapter, comprising a top surface and a bottom surface, and a through hole extending from the top surface to the bottom, wherein the top surface comprises one or more positioning markers and/or fiducial markers and wherein the bottom surface is configured to contact and to be supported by a substrate, wherein the through hole is configured to be positioned over the substrate to form a space (e.g., sample well) configured to contain a biological sample affixed to the substrate; and optionally, instructions for use thereof. In some aspects, the kit comprises instructions for using any one or more or all component parts of the kit. In some embodiments, the adapter comprises one or more positional markers and/or fiducial markers on the top surface, on the bottom surface, and/or within the adapter. In some embodiments, the adapter is adhesive on the bottom surface.

In some embodiments, the kit is a kit for preparing a biological sample and a substrate to which the biological sample is affixed for in situ analysis, particularly for automated open-well, multiplexed sample preparation and in situ analysis.

### B. Additional Kit Components

In some embodiments, the kits can contain reagents and/or consumables required for performing one or more steps of the provided methods. For example, in some embodiments, the kit comprises one or more hydrophilic compositions as described in the methods of the present disclosure. In some embodiments, the kit comprises one or more of buffer, enzyme, chemical, probe, and/or other reagent suitable for preparing the hydrophilic composition(s) as provided herein.

In some embodiments, the kits contain reagents for fixing, embedding, and/or permeabilizing the biological sample. In some embodiments, the kits contain reagents, such as enzymes and buffers for ligation and/or amplification, such as ligases and/or polymerases. In some aspects, the kit can also comprise any of the reagents described herein, e.g., wash buffer and ligation buffer. In some embodiments, the kits contain reagents for detection and/or sequencing, such as detectable probes or detectable labels. In some embodiments, the kits contain other components, for example nucleic acid primers, enzymes and reagents, buffers, nucleotides, photoreactive nucleotides, and/or reagents for additional assays.

In still other embodiments, the kits further comprise one or more reagents for performing the analytical methods provided herein. In some embodiments, the kits further comprise one or more reagents required for one or more steps comprising hybridization, ligation, extension, detection, sequencing, and/or sample preparation as described herein. In some embodiments, the kit further comprises a target nucleic acid, e.g., any described in Section III. In some embodiments, any or all of the oligonucleotides are DNA molecules. In some embodiments, the target nucleic acid is a messenger RNA molecule. In some embodiments, the target nucleic acid is a probe (e.g., a padlock probe) or an amplification product thereof (e.g., a rolling circle amplification product, such as a nucleic acid concatemer). The various components of the kit may be present in separate containers or certain compatible components may be precombined into a single container. In some embodiments, the kits further contain instructions for using the components of the kit to practice the provided methods.

### VI. Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

The terms “polynucleotide,” “polynucleotide,” and “nucleic acid molecule”, used interchangeably herein, refer to polymeric forms of nucleotides of any length, either ribonucleotides or deoxyribonucleotides. Thus, this term comprises, but is not limited to, single-, double-, or multi- stranded DNA or RNA, genomic DNA, cDNA, DNA-RNA hybrids, or a polymer comprising purine and pyrimidine bases or other natural, chemically or biochemically modified, non-natural, or derivatized nucleotide bases. The backbone of the polynucleotide can comprise sugars and phosphate groups (as may typically be found in RNA or DNA), or modified or substituted sugar or phosphate groups.

“Hybridization” as used herein may refer to the process in which two single-stranded polynucleotides bind non-covalently to form a stable double-stranded polynucleotide. In one aspect, the resulting double-stranded polynucleotide can be a “hybrid” or “duplex.” “Hybridization conditions” typically include salt concentrations of approximately less than 1 M, often less than about 500 mM and may be less than about 200 mM. A “hybridization buffer” includes a buffered salt solution such as 5% SSPE, or other such buffers with similar properties. Hybridization temperatures can be as low as 5° C., but are typically greater than 22° C., and more typically greater than about 30° C., and typically in excess of 37° C. Hybridizations are often performed under stringent conditions, e.g., conditions under which a sequence will hybridize to its target sequence but will not hybridize to other, non-complementary sequences. Stringent conditions are sequence-dependent and are different in different circumstances. For example, longer fragments may require higher hybridization temperatures for specific hybridization than short fragments. As other factors may affect the stringency of hybridization, including base composition and length of the complementary strands, presence of organic solvents, and the extent of base mismatching, the combination of parameters is more important than the absolute measure of any one parameter alone. Generally stringent conditions are selected to be about 5° C. lower than the Tₘ for the specific sequence at a defined ionic strength and pH. The melting temperature Tₘ can be the temperature at which a population of double-stranded nucleic acid molecules becomes half dissociated into single strands. As indicated by standard references, a simple estimate of the Tₘ value may be calculated by the equation, Tₘ =81.5 + 0.41 (% G + C), when a nucleic acid is in aqueous solution at 1 M NaCl (see e.g., Anderson and Young, Quantitative Filter Hybridization, in Nucleic Acid Hybridization (1985)). Other references (e.g., Allawi and SantaLucia, Jr., Biochemistry, 36:10581-94 (1997)) include alternative methods of computation which take structural and environmental, as well as sequence characteristics into account for the calculation of Tₘ.

In general, the stability of a hybrid is a function of the ion concentration and temperature. Typically, a hybridization reaction is performed under conditions of lower stringency, followed by washes of varying, but higher, stringency. Exemplary stringent conditions include a salt concentration of at least 0.01 M to no more than 1 M sodium ion concentration (or other salt) at a pH of about 7.0 to about 8.3 and a temperature of at least 25° C. For example, conditions of 5 × SSPE (750 mM NaCl, 50 mM sodium phosphate, 5 mM EDTA at pH 7.4) and a temperature of approximately 30° C. are suitable for allele-specific hybridizations, though a suitable temperature depends on the length and/or GC content of the region hybridized. In one aspect, “stringency of hybridization” in determining percentage mismatch can be as follows: 1) high stringency: 0.1 × SSPE, 0.1% SDS, 65° C.; 2) medium stringency: 0.2 × SSPE, 0.1% SDS, 50° C. (also referred to as moderate stringency); and 3) low stringency: 1.0 × SSPE, 0.1% SDS, 50° C. It is understood that equivalent stringencies may be achieved using alternative buffers, salts and temperatures. For example, moderately stringent hybridization can refer to conditions that permit a nucleic acid molecule such as a probe to bind a complementary nucleic acid molecule. The hybridized nucleic acid molecules generally have at least 60% identity, including for example at least any of 70%, 75%, 80%, 85%, 90%, or 95% identity. Moderately stringent conditions can be conditions equivalent to hybridization in 50% formamide, 5 × Denhardt’s solution, 5x SSPE, 0.2% SDS at 42° C., followed by washing in 0.2 × SSPE, 0.2% SDS, at 42° C. High stringency conditions can be provided, for example, by hybridization in 50% formamide, 5 × Denhardt’s solution, 5 × SSPE, 0.2% SDS at 42° C., followed by washing in 0.1 × SSPE, and 0.1% SDS at 65° C. Low stringency hybridization can refer to conditions equivalent to hybridization in 10% formamide, 5 × Denhardt’s solution, 6 × SSPE, 0.2% SDS at 22° C., followed by washing in 1x SSPE, 0.2% SDS, at 37° C. Denhardt’s solution contains 1% Ficoll, 1% polyvinylpyrolidone, and 1% bovine serum albumin (BSA). 20 × SSPE (sodium chloride, sodium phosphate, ethylene diamide tetraacetic acid (EDTA)) contains 3M sodium chloride, 0.2 M sodium phosphate, and 0.025 M EDTA. Other suitable moderate stringency and high stringency hybridization buffers and conditions are described, for example, in Sambrook et al., Molecular Cloning: A Laboratory Manual, 2nd ed., Cold Spring Harbor Press, Plainview, N.Y. (1989); and Ausubel et al., Short Protocols in Molecular Biology, 4th ed., John Wiley & Sons (1999), all of which are herein incorporated by reference in their entireties.

Alternatively, substantial complementarity exists when an RNA or DNA strand will hybridize under selective hybridization conditions to its complement. Typically, selective hybridization will occur when there is at least about 65% complementary over a stretch of at least 14 to 25 nucleotides, preferably at least about 75%, more preferably at least about 90% complementary. See M. Kanehisa, Nucleic Acids Res. 12:203 (1984), which is incorporated herein by reference in its entirety.

A “primer” used herein can be an oligonucleotide, either natural or synthetic, that is capable, upon forming a duplex with a polynucleotide template, of acting as a point of initiation of nucleic acid synthesis and being extended from its 3′ end along the template so that an extended duplex is formed. The sequence of nucleotides added during the extension process is determined by the sequence of the template polynucleotide. Primers usually are extended by a DNA polymerase.

“Ligation” may refer to the formation of a covalent bond or linkage between the termini of two or more nucleic acids, e.g., oligonucleotides and/or polynucleotides, in a template-driven reaction. The nature of the bond or linkage may vary widely and the ligation may be carried out enzymatically or chemically. As used herein, ligations are usually carried out enzymatically to form a phosphodiester linkage between a 5′ carbon terminal nucleotide of one oligonucleotide with a 3′ carbon of another nucleotide.

“Sequencing,” “sequence determination” and the like means determination of information relating to the nucleotide base sequence of a nucleic acid. Such information may include the identification or determination of partial as well as full sequence information of the nucleic acid. Sequence information may be determined with varying degrees of statistical reliability or confidence. In one aspect, the term includes the determination of the identity and ordering of a plurality of contiguous nucleotides in a nucleic acid. “High throughput digital sequencing” or “next generation sequencing” means sequence determination using methods that determine many (typically thousands to billions) of nucleic acid sequences in an intrinsically parallel manner, e.g. where DNA templates are prepared for sequencing not one at a time, but in a bulk process, and where many sequences are read out preferably in parallel, or alternatively using an ultra-high throughput serial process that itself may be parallelized. Such methods include but are not limited to pyrosequencing (for example, as commercialized by 454 Life Sciences, Inc., Branford, Conn.); sequencing by ligation (for example, as commercialized in the SOLiD™ technology, Life Technologies, Inc., Carlsbad, Calif.); sequencing by synthesis using modified nucleotides (such as commercialized in TruSeq™ and HiSeq™ technology by Illumina, Inc., San Diego, Calif.; HeliScope™ by Helicos Biosciences Corporation, Cambridge, Ma.; and PacBio RS by Pacific Biosciences of California, Inc., Menlo Park, Calif.), sequencing by ion detection technologies (such as Ion Torrent™ technology, Life Technologies, Carlsbad, Calif.); sequencing of DNA nanoballs (Complete Genomics, Inc., Mountain View, Calif.); nanopore-based sequencing technologies (for example, as developed by Oxford Nanopore Technologies, LTD, Oxford, UK), and like highly parallelized sequencing methods.“Multiplexing” or “multiplex assay” herein may refer to an assay or other analytical method in which the presence and/or amount of multiple targets, e.g., multiple nucleic acid target sequences, can be assayed simultaneously by using more than one capture probe conjugate, each of which has at least one different detection characteristic, e.g., fluorescence characteristic (for example excitation wavelength, emission wavelength, emission intensity, FWHM (full width at half maximum peak height), or fluorescence lifetime) or a unique nucleic acid or protein sequence characteristic.

The term “about” as used herein refers to the usual error range for the respective value readily known to the skilled person in this technical field. Reference to “about” a value or parameter herein comprises (and describes) embodiments that are directed to that value or parameter per se.

As used herein, the singular forms “a,” “an,” and “the” comprise plural referents unless the context clearly dictates otherwise. For example, “a” or “an” means “at least one” or “one or more.”

Throughout this disclosure, various aspects of the claimed subject matter are presented in a range format. It should be understood that the description in range format is merely for convenience and brevity and should not be construed as an inflexible limitation on the scope of the claimed subject matter. Accordingly, the description of a range should be considered to have specifically disclosed all the possible sub-ranges as well as individual numerical values within that range. For example, where a range of values is provided, it is understood that each intervening value, between the upper and lower limit of that range and any other stated or intervening value in that stated range is encompassed within the claimed subject matter. The upper and lower limits of these smaller ranges may independently be comprised in the smaller ranges, and are also encompassed within the claimed subject matter, subject to any specifically excluded limit in the stated range. Where the stated range comprises one or both of the limits, ranges excluding either or both of those comprised limits are also comprised in the claimed subject matter. This applies regardless of the breadth of the range.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Similarly, use of a), b), etc., or i), ii), etc. does not by itself connote any priority, precedence, or order of steps in the claims. Similarly, the use of these terms in the specification does not by itself connote any required priority, precedence, or order.

### EXAMPLES

The presently disclosed subject matter will be better understood by reference to the following Examples, which are provided as exemplary of the present disclosure, and not by way of limitation.

### Example 1: Adapter Method for Adapting a Biological Sample on Any Slide for In Situ Analysis

The present example describes an exemplary method for processing a biological sample by using an adapter for in situ analysis with a biological sample affixed to any substrate, such as a glass microscopy slide. The substrate may be unmodified or have partial modifications.

Starting with a tissue section sample already immobilized on the substrate, the sample is fixed and permeabilized. An adapter having a through hole configured to the shape, size and location of the tissue sample on the substrate and further having positional markers and/or fiducial markers and/or surface functionalization is obtained. The adapter is placed on the substrate so that the tissue sample sits within the confines of the through hole and any positional markers and/or fiducial markers are oriented facing upward away from the substrate. The adapter is affixed securely to the substrate so that the adapter forms a liquid-tight seal with the substrate, and the through hole of the adapter and substrate form an effective sample well containing the tissue sample.

A hydrophilic composition comprising one or more of buffer, enzyme, chemical, probe, and/or other reagent is then delivered to the tissue sample via the through hole to allow for sample processing and/or in situ analysis. The hydrophilic composition is contained within the sample well formed by a hydrophobic coating on the adapter or by the adapter material (e.g., composed of hydrophobic material). The biological sample is optionally processed using other sample processing techniques known in the art (e.g., permeabilizing, fixing, prefixing, crosslinking, clearing, expanding, histological staining, and/or de-crosslinking, etc. in any suitable order) prior to, during, or after the in situ analysis.

The hydrophilic composition may remain for subsequent in situ analysis. Alternatively, the hydrophilic composition may be removed and replaced with another hydrophilic composition comprising one or more of buffer, enzyme, chemical, probe, and/or other reagent for subsequent in situ analysis. The biological sample remains covered by a hydrophilic composition throughout sample preparation and during in situ analysis but is not further covered by a coverslip. For in situ analysis, such as fluorescence in situ hybridization imaging, a dipping objective of a suitable microscope or optical component of any other imaging device may be directly onto the surface of the exposed hydrophilic composition covering the biological sample in order to acquire imaging data.

Additional rounds of detection and analysis may be carried out on the same biological sample through sequential cycles of removal of the hydrophilic composition from the sample, and the addition of one or more further hydrophilic compositions as needed, to provide the desired stripping agents, washing buffers, quenching reagents, probes (e.g., nucleic acid probes), imaging buffers, etc., to prepare the sample for further imaging and analysis.

The present disclosure is not intended to be limited in scope to the particular disclosed embodiments, which are provided, for example, to illustrate various aspects of the disclosure. Various modifications to the compositions and methods described will become apparent from the description and teachings herein. Such variations may be practiced without departing from the true scope and spirit of the disclosure and are intended to fall within the scope of the present disclosure.

1. A method for analyzing a biological sample on a substrate, comprising:
(a) applying an adapter to the substrate, wherein:
the adapter comprises a top surface and a bottom surface, and a through hole surrounding a region of interest in the biological sample, wherein:
the bottom surface forms a substantially impervious seal with the substrate; and
an area of the adapter surrounding the region of interest is hydrophobic;
(b) delivering a hydrophilic composition to cover the region of interest, wherein the hydrophilic composition covering the region of interest is contained in the through hole by the substantially impervious seal and the hydrophobic area surrounding the region of interest,
wherein the method does not comprise applying a cover to the adapter to enclose the region of interest.

2. The method of claim 1, wherein the adapter comprises one or more positional markers and/or fiducial markers on the top surface, on the bottom surface, and/or within the adapter.

3-6. (canceled)

7. The method of claim 1, wherein the adapter is composed of polypropylene, polytetrafluoroethylene (PTFE), any silica-based materials, and/or paraffin coated materials.

8. The method of claim 1, wherein the adapter comprises a hydrophobic coating on an inner surface of the through hole, the top surface of the adapter or a portion of the top surface surrounding the region of interest, and/or on the bottom surface of the adapter or a portion of the bottom surface surrounding the region of interest.

9. The method of , claim 1, wherein the thickness of the adapter between the top surface and the bottom surface is no more than about 0.5 mm, no more than about 0.4 mm, no more than about 0.3 mm, no more than about 0.2 mm, no more than about 0.1 mm, no more than about 90 µm, no more than about 80 µm, no more than about 70 µm, no more than about 60 µm, no more than about 50 µm, no more than about 40 µm, no more than about 30 µm, no more than about 20 µm, or no more than about 10 µm.

10-13. (canceled)

14. The method of claim 1, comprising modifying the area surrounding the region of interest to be hydrophobic or more hydrophobic than prior to the modification.

15-18. (canceled)

19. The method of , claim 1, wherein the adapter is not secured to the substrate by any physical device and/or structure or sandwiched between the substrate and any physical device and/or structure.

20. The method of claim 1, wherein:
(i) the bottom surface and/or its corresponding surface on the substrate is adhesive; or
(ii) the bottom surface and its corresponding surface on the substrate are bonded by an adhesive material; or
(iii) the adapter contains an adhesive on its top surface and an adhesive on its bottom surface; or
(iv) any combination of (i)-(iii).

21-23. (canceled)

24. The method of claim 1, comprising selecting the adapter with a pre-configured through hole size and/or shape according to the size and/or shape of the region of interest, such that the selected adapter surrounds the region of interest upon application to the substrate.

25. The method of claim 1, comprising customizing the size and/or shape of the through hole according to the size and/or shape of the region of interest, such that the customized adapter surrounds the region of interest upon application to the substrate.

26. The method of claim 1, wherein the substrate is a pre-prepared or archived substrate comprising the biological sample immobilized thereon.

27. (canceled)

28. The method of claim 1, wherein the adapter is applied to the substrate according to the location of the biological sample on the substrate and/or according to the location of the region of interest in the biological sample.

29-31. (canceled)

32. The method of claim 1, wherein the biological sample is not embedded in a matrix.

33. (canceled)

34. The method of claim 1, wherein the hydrophilic composition is delivered to the through hole via an opening on the top surface that extends to the bottom surface.

35. The method of claim 34, wherein the through hole opening on the top surface is not covered when delivering the hydrophilic composition in step (b).

36. The method of claim 1, wherein the adapter comprises one or more barcodes.

37-44. (canceled)

45. The method of claim 1, further comprising:
(c) allowing a reaction between a molecule in the region of interest and one or more agents in the hydrophilic composition;
(d) detecting a signal associated with the reaction or a product thereof, thereby detecting the molecule in situ in the biological sample, optionally wherein the detection is by dipping an objective of a microscope in the hydrophilic composition;
(e) removing the hydrophilic composition after the reaction from the through hole through its opening on the top surface; and
(f) delivering another hydrophilic composition to cover the region of interest and repeating steps (c)-(e) in one or more sequential cycles.

46-49. (canceled)

50. The method of claim 1, wherein the method does not comprise applying a cover slip to the adapter to enclose the region of interest.

51. A method for analyzing a biological sample, comprising:
(a) applying an adapter to a planar substrate having the biological sample immobilized thereon, wherein:
the adapter comprises a top surface and a bottom surface, and a through hole surrounding a region of interest in the biological sample, wherein:
the bottom surface forms a substantially impervious seal with the planar substrate; and
an area of the adapter surrounding the region of interest is hydrophobic;
(b) delivering a hydrophilic composition to cover the region of interest, wherein the hydrophilic composition covering the region of interest is contained in the through hole by the substantially impervious seal and the hydrophobic area surrounding the region of interest;
(c) allowing a reaction between a molecule in the region of interest and one or more agents in the hydrophilic composition;
(d) dipping an objective of a microscope in the hydrophilic composition contained in the through hole; and
(e) detecting a signal associated with the reaction or a product thereof through the objective dipped in the hydrophilic composition, thereby detecting the molecule in situ in the biological sample.

52. The method of claim 51, wherein the adapter comprises one or more positional markers and/or fiducial markers on the top surface, on the bottom surface, and/or within the adapter.

53. The method of claim 51, wherein the thickness of the adapter between the top surface and the bottom surface is no more than about 100 µm, no more than about 90 µm, no more than about 80 µm, no more than about 70 µm, no more than about 60 µm, no more than about 50 µm, no more than about 40 µm, no more than about 30 µm, no more than about 20 µm, or no more than about 10 µm.

54. (canceled)

55. An adapter, comprising a top surface and a bottom surface, and a through hole configured to surround a region of interest in a biological sample, wherein:
the adapter contains an adhesive on its bottom surface and/or an adhesive on its top surface
the adapter comprises one or more positional markers and/or fiducial markers on the top surface, on the bottom surface, and/or within the adapter;
an area of the adapter configured to surround the region of interest is hydrophobic; and
the thickness of the adapter is no more than about 200 µm.

56-60. (canceled)

61. The adapter of claim 55, wherein the adapter is composed of polypropylene, polytetrafluoroethylene (PTFE), any silica-based materials, and/or paraffin coated materials.

62. The adapter of claim 55, wherein the adapter comprises a hydrophobic coating on an inner surface of the through hole, the top surface of the adapter or a portion of the top surface surrounding the region of interest, and/or on the bottom surface of the adapter or a portion of the bottom surface surrounding the region of interest.

63. The adapter of claim 55, wherein the through hole runs from the top surface to the bottom surface of the adapter, the top surface is hydrophobic, and the bottom surface is configured to form a substantially impervious seal with a substrate.

64-65. (canceled)
